(19) United States
(12) Patent Application Publication
(10) Pub. No.: US 2026/0101284 A1
(43) Pub. Date: Apr. 9, 2026

(54) DOWNLINK CONTROL CHANNEL MONITORING OCCASION CONFIGURATION FOR ON-DEMAND SYSTEM INFORMATION

(71) Applicant: QUALCOMM Incorporated, San Diego, CA (US)

(72) Inventors: Jianghong LUO, Skillman, NJ (US); Navid ABEDINI, Basking Ridge, NJ (US); Hung Dinh LY, San Diego, CA (US)

(21) Appl. No.: 19/243,571

(22) Filed: Jun. 19, 2025

Related U.S. Application Data
(60) Provisional application No. 63/703,825, filed on Oct. 4, 2024.

(51) Int. Cl. H04W 52/02; H04W 72/23; H04W 74/0833

(52) U.S. Cl. CPC H04W 52/0235; H04W 72/23; H04W 74/0833

(57) ABSTRACT

Methods, systems, and devices for wireless communications are described. A user equipment (UE) may receive an indication of an uplink wake up signal (WUS) configuration for on-demand system information block 1 (SIB1) triggered by a WUS. The UE may receive, during a random access response (RAR) window, an RAR message based on the uplink wake up signal. The UE may monitor for one or more on-demand SIBs during a physical downlink control channel (PDCCH) window. In some examples, the uplink WUS configuration or the RAR message may indicate a start time and duration of the PDCCH window. In some examples, a network entity may use slot aggregation to transmit repeated on-demand SIB1s. The RAR message or the uplink WUS configuration may indicate a slot aggregation parameter.

### CROSS REFERENCES

The present Application for Patent claims benefit of U.S. Provisional Ser. No. 63/703,825 by LUO et al., entitled “DOWNLINK CONTROL CHANNEL MONITORING OCCASION CONFIGURATION FOR ON-DEMAND SYSTEM INFORMATION,” filed Oct. 4, 2024, assigned to the assignee hereof, and expressly incorporated herein.

### FIELD OF TECHNOLOGY

The following relates to wireless communications, including downlink control channel monitoring occasion configuration for on-demand system information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a control signal indicating an uplink wake up signal (WUS) configuration for on-demand system information block 1 (SIB1) that is triggered by an uplink WUS, receiving, during a random access response (RAR) window, an RAR message based on the uplink WUS, and monitoring, based on the RAR message and during a physical downlink control channel window, for one or more on-demand SIBs, where the physical downlink control channel window includes a start time and a duration.

A UE for wireless communications is described. The UE may include one or more memories storing processor executable code, and one or more processors coupled with the one or more memories. The one or more processors may individually or collectively be operable to execute the code to cause the UE to receive a control signal indicating an uplink WUS configuration for on-demand SIB1 that is triggered by an uplink WUS, receive, during an RAR window, an RAR message based on the uplink WUS, and monitor, based on the RAR message and during a physical downlink control channel window, for one or more on-demand SIBs, where the physical downlink control channel window includes a start time and a duration.

Another UE for wireless communications is described. The UE may include means for receiving a control signal indicating an uplink WUS configuration for on-demand SIB1 that is triggered by an uplink WUS, means for receiving, during an RAR window, an RAR message based on the uplink WUS, and means for monitoring, based on the RAR message and during a physical downlink control channel window, for one or more on-demand SIBs, where the physical downlink control channel window includes a start time and a duration.

A non-transitory computer-readable medium storing code for wireless communications is described. The code may include instructions executable by one or more processors to receive a control signal indicating an uplink WUS configuration for on-demand SIB1 that is triggered by an uplink WUS, receive, during an RAR window, an RAR message based on the uplink WUS, and monitor, based on the RAR message and during a physical downlink control channel window, for one or more on-demand SIBs, where the physical downlink control channel window includes a start time and a duration.

Some examples of the method, UEs, and non-transitory computer-readable medium described herein may further include operations, features, means, or instructions for receiving an indication of the start time, the duration, or both, from the uplink WUS configuration.

Some examples of the method, UEs, and non-transitory computer-readable medium described herein may further include operations, features, means, or instructions for receiving an indication of the start time, the duration, or both, from the RAR message.

In some examples of the method, UEs, and non-transitory computer-readable medium described herein, the RAR message indicates one or more values, an index to a list of values, one or more delta values, or any combination thereof, to indicate the start time or the duration, or both.

In some examples of the method, UEs, and non-transitory computer-readable medium described herein, the start time of the physical downlink control channel window occurs after a time offset from a reference time point.

In some examples of the method, UEs, and non-transitory computer-readable medium described herein, the start time of the physical downlink control channel window aligns with a start of an earliest downlink control channel occasion after the time offset based on an index of a received synchronization signal block.

In some examples of the method, UEs, and non-transitory computer-readable medium described herein, the reference time point corresponds to the RAR window or a time of reception of the RAR message.

In some examples of the method, UEs, and non-transitory computer-readable medium described herein, the reference time point may be configured via a static configuration, the uplink WUS configuration, the RAR message, or any combination thereof.

In some examples of the method, UEs, and non-transitory computer-readable medium described herein, the time offset may be specified in a technical specification based on a physical downlink shared channel processing latency for the RAR message.

In some examples of the method, UEs, and non-transitory computer-readable medium described herein, the reference time point may be specified in a technical specification.

In some examples of the method, UEs, and non-transitory computer-readable medium described herein, the start time corresponds to a slot boundary or a symbol boundary based on a first downlink subcarrier spacing indicated by a master information block or a second downlink subcarrier spacing indicated by the uplink WUS configuration.

In some examples of the method, UEs, and non-transitory computer-readable medium described herein, the duration of the physical downlink control channel window corresponds to a first quantity of milliseconds, a second quantity of slots, a third quantity of synchronization signal block periods, or any combination thereof and the second quantity of slots may be based on a first downlink subcarrier spacing indicated by a master information block or a second downlink subcarrier spacing indicated by the uplink WUS configuration.

A method for wireless communications by a UE is described. The method may include receiving a control signal indicating an uplink WUS configuration for on-demand SIB1 that is triggered by an uplink WUS, receiving, during an RAR window, an RAR message based on the uplink WUS, and monitoring a set of multiple physical downlink control channel monitoring occasions for a respective set of multiple SIBs based on a slot aggregation parameter indicated via the uplink WUS configuration or the RAR message, or both.

A UE for wireless communications is described. The UE may include one or more memories storing processor executable code, and one or more processors coupled with the one or more memories. The one or more processors may individually or collectively be operable to execute the code to cause the UE to receive a control signal indicating an uplink WUS configuration for on-demand SIB1 that is triggered by an uplink WUS, receive, during an RAR window, an RAR message based on the uplink WUS, and monitor a set of multiple physical downlink control channel monitoring occasions for a respective set of multiple SIBs based on a slot aggregation parameter indicated via the uplink WUS configuration or the RAR message, or both.

Another UE for wireless communications is described. The UE may include means for receiving a control signal indicating an uplink WUS configuration for on-demand SIB1 that is triggered by an uplink WUS, means for receiving, during an RAR window, an RAR message based on the uplink WUS, and means for monitoring a set of multiple physical downlink control channel monitoring occasions for a respective set of multiple SIBs based on a slot aggregation parameter indicated via the uplink WUS configuration or the RAR message, or both.

A non-transitory computer-readable medium storing code for wireless communications is described. The code may include instructions executable by one or more processors to receive a control signal indicating an uplink WUS configuration for on-demand SIB1 that is triggered by an uplink WUS, receive, during an RAR window, an RAR message based on the uplink WUS, and monitor a set of multiple physical downlink control channel monitoring occasions for a respective set of multiple SIBs based on a slot aggregation parameter indicated via the uplink WUS configuration or the RAR message, or both.

In some examples of the method, UEs, and non-transitory computer-readable medium described herein, monitoring the set of multiple physical downlink control channel monitoring occasions may include operations, features, means, or instructions for monitoring the set of multiple physical downlink control channel monitoring occasions across a set of multiple SIB transmission repetition periods, where a physical downlink control channel monitoring window includes the set of multiple SIB transmission repetition periods.

Some examples of the method, UEs, and non-transitory computer-readable medium described herein may further include operations, features, means, or instructions for receiving a physical downlink control channel signal scheduling a grant in a first physical downlink control channel monitoring occasion within a physical downlink control channel monitoring window, where the grant schedules a physical downlink shared channel slot aggregation for transmission of a SIB over consecutive slots based on the slot aggregation parameter.

Some examples of the method, UEs, and non-transitory computer-readable medium described herein may further include operations, features, means, or instructions for receiving an indication of the slot aggregation parameter, a duration of a physical downlink control channel window, and a time offset to the physical downlink control channel window via the RAR message or via the uplink WUS configuration, or both.

A method for wireless communications by a network entity is described. The method may include outputting a control signal indicating an uplink WUS configuration for on-demand SIB1 that is triggered by an uplink WUS, outputting, during an RAR window, an RAR message based on the uplink WUS, and outputting, based on the RAR message and during a physical downlink control channel window, one or more on-demand SIBs, where the physical downlink control channel window includes a start time and a duration.

A network entity for wireless communications is described. The network entity may include one or more memories storing processor executable code, and one or more processors coupled with the one or more memories. The one or more processors may individually or collectively be operable to execute the code to cause the network entity to output a control signal indicating an uplink WUS configuration for on-demand SIB1 that is triggered by an uplink WUS, output, during an RAR window, an RAR message based on the uplink WUS, and output, based on the RAR message and during a physical downlink control channel window, one or more on-demand SIBs, where the physical downlink control channel window includes a start time and a duration.

Another network entity for wireless communications is described. The network entity may include means for outputting a control signal indicating an uplink WUS configuration for on-demand SIB1 that is triggered by an uplink WUS, means for outputting, during an RAR window, an RAR message based on the uplink WUS, and means for outputting, based on the RAR message and during a physical downlink control channel window, one or more on-demand SIBs, where the physical downlink control channel window includes a start time and a duration.

A non-transitory computer-readable medium storing code for wireless communications is described. The code may include instructions executable by one or more processors to output a control signal indicating an uplink WUS configuration for on-demand SIB1 that is triggered by an uplink WUS, output, during an RAR window, an RAR message based on the uplink WUS, and output, based on the RAR message and during a physical downlink control channel window, one or more on-demand SIBs, where the physical downlink control channel window includes a start time and a duration.

Some examples of the method, network entities, and non-transitory computer-readable medium described herein may further include operations, features, means, or instructions for outputting an indication of the start time, the duration, or both, via the uplink WUS configuration.

Some examples of the method, network entities, and non-transitory computer-readable medium described herein may further include operations, features, means, or instructions for outputting an indication of the start time, the duration, or both, via the RAR message.

In some examples of the method, network entities, and non-transitory computer-readable medium described herein, the RAR message indicates one or more values, an index to a list of values, one or more delta values, or any combination thereof, to indicate the start time or the duration, or both.

In some examples of the method, network entities, and non-transitory computer-readable medium described herein, the start time of the physical downlink control channel window occurs after a time offset from a reference time point.

In some examples of the method, network entities, and non-transitory computer-readable medium described herein, the start time of the physical downlink control channel window aligns with a start of an earliest downlink control channel occasion after the time offset based on an index of an outputted synchronization signal block.

In some examples of the method, network entities, and non-transitory computer-readable medium described herein, the reference time point corresponds to the RAR window or a time of reception of the RAR message.

In some examples of the method, network entities, and non-transitory computer-readable medium described herein, the reference time point may be configured via a static configuration, the uplink WUS configuration, the RAR message, or any combination thereof.

In some examples of the method, network entities, and non-transitory computer-readable medium described herein, the start time corresponds to a slot boundary or a symbol boundary based on a first downlink subcarrier spacing indicated by a master information block or a second downlink subcarrier spacing indicated by the uplink WUS configuration.

In some examples of the method, network entities, and non-transitory computer-readable medium described herein, the duration of the physical downlink control channel window corresponds to a first quantity of milliseconds, a second quantity of slots, a third quantity of synchronization signal block periods, or any combination thereof and the second quantity of slots may be based on a first downlink subcarrier spacing indicated by a master information block or a second downlink subcarrier spacing indicated by the uplink WUS configuration.

Some examples of the method, network entities, and non-transitory computer-readable medium described herein may further include operations, features, means, or instructions for outputting, during the RAR window, a second RAR message based on a second WUS, where the RAR message indicates a first time offset to the physical downlink control channel window, and the second RAR message indicates a second time offset to the physical downlink control channel window.

Some examples of the method, network entities, and non-transitory computer-readable medium described herein may further include operations, features, means, or instructions for outputting, during the RAR window, a second RAR message based on a second WUS, where the RAR message indicates a first time offset to the physical downlink control channel window, and the second RAR message indicates the first time offset to a second physical downlink control channel window.

A method for wireless communications by a network entity is described. The method may include outputting a control signal indicating an uplink WUS configuration for on-demand SIB1 that is triggered by an uplink WUS, outputting, during an RAR window, an RAR message based on the uplink WUS, and outputting, during a set of multiple physical downlink control channel monitoring occasions, a respective set of multiple SIBs based on a slot aggregation parameter indicated via the uplink WUS configuration or the RAR message, or both.

A network entity for wireless communications is described. The network entity may include one or more memories storing processor executable code, and one or more processors coupled with the one or more memories. The one or more processors may individually or collectively be operable to execute the code to cause the network entity to output a control signal indicating an uplink WUS configuration for on-demand SIB1 that is triggered by an uplink WUS, output, during an RAR window, an RAR message based on the uplink WUS, and output, during a set of multiple physical downlink control channel monitoring occasions, a respective set of multiple SIBs based on a slot aggregation parameter indicated via the uplink WUS configuration or the RAR message, or both.

Another network entity for wireless communications is described. The network entity may include means for outputting a control signal indicating an uplink WUS configuration for on-demand SIB1 that is triggered by an uplink WUS, means for outputting, during an RAR window, an RAR message based on the uplink WUS, and means for outputting, during a set of multiple physical downlink control channel monitoring occasions, a respective set of multiple SIBs based on a slot aggregation parameter indicated via the uplink WUS configuration or the RAR message, or both.

A non-transitory computer-readable medium storing code for wireless communications is described. The code may include instructions executable by one or more processors to output a control signal indicating an uplink WUS configuration for on-demand SIB1 that is triggered by an uplink WUS, output, during an RAR window, an RAR message based on the uplink WUS, and output, during a set of multiple physical downlink control channel monitoring occasions, a respective set of multiple SIBs based on a slot aggregation parameter indicated via the uplink WUS configuration or the RAR message, or both.

In some examples of the method, network entities, and non-transitory computer-readable medium described herein, the respective set of multiple SIBs may be outputted across a set of multiple SIB transmission repetition periods and a physical downlink control channel monitoring window includes the set of multiple SIB transmission repetition periods.

Some examples of the method, network entities, and non-transitory computer-readable medium described herein may further include operations, features, means, or instructions for outputting a physical downlink control channel signal scheduling a grant in a first physical downlink control channel monitoring occasion within a physical downlink control channel monitoring window, where the grant schedules a physical downlink shared channel slot aggregation for transmission of a SIB over consecutive slots based on the slot aggregation parameter.

Some examples of the method, network entities, and non-transitory computer-readable medium described herein may further include operations, features, means, or instructions for outputting, during a second RAR window, a second RAR message based on a second uplink WUS, where the RAR message indicates the slot aggregation parameter, and the second RAR message indicates a second slot aggregation parameter.

Some examples of the method, network entities, and non-transitory computer-readable medium described herein may further include operations, features, means, or instructions for outputting, during a second RAR window, a second RAR message based on a second uplink WUS, where the RAR message indicates first timing information for a first physical downlink control channel window, and the second RAR message indicates second timing information for a second physical downlink control channel window.

Some examples of the method, network entities, and non-transitory computer-readable medium described herein may further include operations, features, means, or instructions for outputting an indication of the slot aggregation parameter, a duration of a physical downlink control channel window, and a time offset to the physical downlink control channel window via the RAR message or via the uplink WUS configuration, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports downlink control channel monitoring occasion configuration for on-demand system information in accordance with one or more aspects of the present disclosure.

FIG. 2 shows an example of a wireless communications system that supports downlink control channel monitoring occasion configuration for on-demand system information in accordance with one or more aspects of the present disclosure.

FIG. 3 shows an example of a physical downlink control channel (PDCCH) window alignment configuration that supports downlink control channel monitoring occasion configuration for on-demand system information in accordance with one or more aspects of the present disclosure.

FIG. 4 shows an example of a slot aggregation configuration that supports downlink control channel monitoring occasion configuration for on-demand system information in accordance with one or more aspects of the present disclosure.

FIG. 5 shows an example of a multiple user equipment (UE) slot aggregation configuration that supports downlink control channel monitoring occasion configuration for on-demand system information in accordance with one or more aspects of the present disclosure.

FIG. 6 shows an example of a process flow that supports downlink control channel monitoring occasion configuration for on-demand system information in accordance with one or more aspects of the present disclosure.

FIG. 7 shows an example of a process flow that supports downlink control channel monitoring occasion configuration for on-demand system information in accordance with one or more aspects of the present disclosure.

FIGS. 8 and 9 show block diagrams of devices that support downlink control channel monitoring occasion configuration for on-demand system information in accordance with one or more aspects of the present disclosure.

FIG. 10 shows a block diagram of a communications manager that supports downlink control channel monitoring occasion configuration for on-demand system information in accordance with one or more aspects of the present disclosure.

FIG. 11 shows a diagram of a system including a device that supports downlink control channel monitoring occasion configuration for on-demand system information in accordance with one or more aspects of the present disclosure.

FIGS. 12 and 13 show block diagrams of devices that support downlink control channel monitoring occasion configuration for on-demand system information in accordance with one or more aspects of the present disclosure.

FIG. 14 shows a block diagram of a communications manager that supports downlink control channel monitoring occasion configuration for on-demand system information in accordance with one or more aspects of the present disclosure.

FIG. 15 shows a diagram of a system including a device that supports downlink control channel monitoring occasion configuration for on-demand system information in accordance with one or more aspects of the present disclosure.

FIGS. 16 through 19 show flowcharts illustrating methods that support downlink control channel monitoring occasion configuration for on-demand system information in accordance with one or more aspects of the present disclosure.

### DETAILED DESCRIPTION

A wireless communications system may implement techniques for network energy savings, such as by implementing on-demand system information or on-demand system information blocks (SIBs). For some implementations of on-demand system information, a network entity may transmit system information, such as a system information block 1 (SIB1), in response to an uplink wake up signal (WUS) received from a user equipment (UE). The network entity may transmit a random access response (RAR) message based on receiving the WUS, and the RAR message may configure the UE to monitor for the on-demand SIB1. In some cases, the UE may begin to monitor a downlink control channel window after a time offset from a reference time point. The reference time point may be, for example, receipt of the RAR message. The network entity may transmit multiple RAR messages within an RAR window. Based on time differences between a first RAR message (e.g., transmitted earlier in the RAR window) and a second RAR message (e.g., transmitted later in the RAR window), the downlink control channel window at the network entity may be larger than the downlink control channel window at a UE. The larger downlink control channel window at the network entity may correspond to higher network energy consumption, as the network entity may be in a higher power state for longer.

A wireless communications system described herein supports techniques for configuring a start time and a duration of a physical downlink control channel (PDCCH) monitoring window for on-demand system information, such as on-demand SIB1. By configuring the start time and the duration of the PDCCH monitoring window, a network-side PDCCH window may be aligned with a UE-side PDCCH window. In some examples, a WUS configuration or the RAR message may indicate the start time or the duration, or both, of the PDCCH window. Additionally, or alternatively, the start time and the duration of the PDCCH window may be statically configured for the wireless communications system. In some examples, the start time may correspond to an offset from a reference time, such as an RAR window. The reference time may be indicated by the WUS configuration, the RAR message, or be statically configured for the wireless communications system. In some examples, different RAR messages, such as for different UEs, transmitted in a same RAR window may indicate different or common parameter values.

In some examples, the wireless communications system may support slot aggregation for on-demand system information, such as on-demand SIB1. The RAR message or the WUS configuration may indicate a slot aggregation parameter for the on-demand system information. A network entity may transmit on-demand SIB in consecutive slots according to the slot aggregation parameter. In some examples, the slot aggregation techniques may include aspects of indicating a start time and duration of a PDCCH monitoring window. For example, if the network entity receives requests for on-demand SIB from different UEs based on different synchronization signal blocks (SSBs), the network entity may indicate different start times and durations for respective downlink control channel windows to transmit the on-demand SIBs to the different UEs.

Aspects of the disclosure are initially described in the context of wireless communications systems. Aspects of the disclosure are further illustrated by and described with reference to PDCCH window alignment configurations, slot aggregation configurations, process flows, apparatus diagrams, system diagrams, and flowcharts that relate to downlink control channel monitoring occasion configuration for on-demand system information.

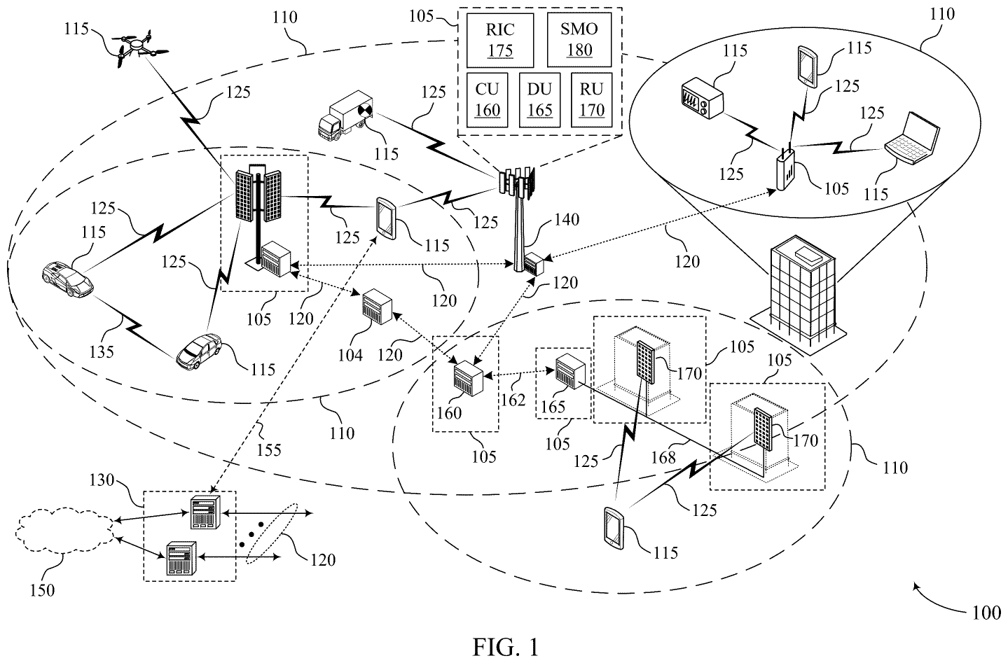

FIG. 1 shows an example of a wireless communications system 100 that supports downlink control channel monitoring occasion configuration for on-demand system information in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support downlink control channel monitoring occasion configuration for on-demand system information as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques for communication of system information. For example, a network entity 105 may transmit SIBs, such as a SIB1, to a UE 115. Some SIBs may be associated with a periodicity. For example, SIB1 may have a periodicity of 160 milliseconds before contents of the SIB1 may be updated or changed. Within the SIB1 periodicity (e.g., 160 milliseconds), the network entity 105 may transmit a SIB1 multiple times according to a SIB1 transmission repetition periodicity. For example, the network entity 105 may transmit a SIB1 eight times if the SIB1 periodicity is 160 milliseconds and the SIB1 transmission repetition periodicity is 20 milliseconds. A UE 115 with low SNR may receive and combine multiple repeated SIB1 to decode the SIB1. In some cases, SIB1 may be beam swept over all transmitted SSBs in consecutive slots within a SIB1 transmission repetition periodicity.

The wireless communications system 100 may implement techniques for network energy savings. For example, the wireless communications system 100 may support on-demand system information, including on-demand SIB1. For example, a network entity 105 may transmit an uplink WUS configuration to a UE 115 indicating parameters for the UE 115 to transmit an uplink WUS to a serving cell, such as a network energy savings serving cell. The UE 115 may receive a SSB of an SSB burst and transmit a WUS to the serving cell during a random access occasion. The WUS may, in some examples, request on-demand system information from the serving cell, such as requesting an on-demand SIB1. In some cases, the WUS may include aspects of a random access preamble. The serving cell may transmit an RAR message to the UE 115 in response to the WUS, and the RAR message may indicate that the UE 115 is to begin monitoring for the on-demand SIB1.

In some cases, the UE 115 may transmit the WUS to request on-demand other system information (OSI). The RAR message may trigger the UE 115 to start monitoring for the on-demand OSI in one or more system information windows. A time offset to the system information window to receive the on-demand OSI may be based on information in SIB1 or statically configured. A duration of the system information window to receive the on-demand OSI may be configured by SIB1. Upon receipt of the RAR message, the UE 115 may monitor one or more system information windows until successful acquisition within a current modification period of the system information.

When requesting on-demand SIB1, an RAR message may trigger the UE 115 to monitor for PDCCH signaling in a PDCCH window. A start of the PDCCH window may be offset from a reference time point. The term “PDCCH window” may be referred to as or include aspects of a PDCCH monitoring window (e.g., from a UE perspective) or a PDCCH transmission window (e.g., from a network perspective).

In some examples, the reference time point may correspond to a reception time of the RAR message. In this example, a same offset may be used for different RAR messages. For example, a first RAR message transmitted early in the RAR window may have a same length offset as a second RAR message transmitted later in the RAR window, such that a first PDCCH monitoring window corresponding to the first RAR message begins earlier than a second PDCCH monitoring window corresponding to the second RAR message. In this case, the network entity 105 may transmit the one-demand SIB1 in a larger PDCCH monitoring window than the UE-side PDCCH monitoring windows, as the network-side PDCCH monitoring window may have a duration equal to a union of all UE-side PDCCH monitoring windows. This example may provide lower latency, but uses higher network energy consumption.

In some examples, the reference time point may correspond to a transmission time of the uplink WUS. The UE 115 may wait for the RAR message to determine whether to retransmit the uplink WUS, as an initial transmission of an uplink WUS may not be successfully received. Therefore, using the transmission time of the uplink WUS may, in some cases, be less reliable than the PDCCH monitoring window being based on a timing related to the RAR message.

In some examples, the reference time point may be based on the RAR window, for example instead of a receipt of a specific RAR within the RAR window. For example, the reference time point may be based on an end of the RAR window. In this example, both the network-side and the UE-side PDCCH monitoring windows may be aligned.

The wireless communications system 100, and wireless communications systems described herein, support additional techniques to provide for aligning UE-side and network-side PDCCH windows by configuring a start time and a duration of a PDCCH window for on-demand system information, such as on-demand SIB1. In some examples, a starting time and a duration of the PDCCH window may be indicated in the RAR message that is response to the uplink WUS. In some examples, the starting time and the duration of the PDCCH window may be indicated in the uplink WUS configuration.

In some examples, the PDCCH window may start right after an offset from a reference time. The PDCCH window may or may not align with a Type-0 PDCCH occasion associated with the uplink WUS occasion. The PDCCH window duration may be based on a target quantity of on-demand SIB1 transmissions and a maximum time offset to the earliest PDCCH occasion.

In some examples, the PDCCH window may align with a corresponding Type-0 PDCCH occasion. A UE 115 may receive a first SSB and transmit an uplink WUS to a serving cell in a random access occasion corresponding to the first SSB. The serving cell may transmit an RAR message to the UE 115 in response to the uplink WUS to configure the UE 115 to monitor for an on-demand SIB1 in a PDCCH window after a time offset from a reference time point. A beginning of the PDCCH window may align with an earliest Type-0 PDCCH occasion corresponding to the first SSB after the time offset. A duration of the PDCCH window may be based on a target quantity of SIB1 transmissions.

The starting time and/or duration of the PDCCH window for the on-demand system information (e.g., on-demand SIB1) may be indicated semi-statically via the uplink WUS configuration, dynamically by the RAR message, statically configured, or any combination thereof. The starting time may be indicated based on an offset from a reference time point. For example, the PDCCH monitoring window may begin right after the offset from the reference time point, or a starting boundary of the PDCCH monitoring window may align with a corresponding PDCCH occasion, as described above. In some examples, the reference time point may be referred to as a reference time.

The wireless communications system 100 may support techniques for a UE 115 to receive multiple on-demand SIB1s within a PDCCH window. For example, a duration of the PDCCH window may be configured to be large enough for the UE 115 to receive a target quantity of repeated SIB1s based on an SNR of the UE 115. For example, the PDCCH window duration may be configured to be equal to the target quantity of repeated SIB1s times the SIB1 transmission repetition periodicity. If, for example, the UE 115 can decode the SIB1 by combining four repetitions of the SIB1, and the SIB1 transmission repetition periodicity is 20 milliseconds long, the PDCCH window may be configured to be at least 80 milliseconds long.

The wireless communications system 100 may support techniques for slot aggregation of on-demand SIB1. Physical downlink shared channel (PDSCH) slot aggregation may be used to transmit repeated SIB1s in consecutive slots to reduce SIB1 acquisition latency and save power consumption for both a network entity 105 and a UE 115. A slot aggregation parameter may be semi-statically indicated via an uplink WUS configuration or dynamically indicated via an RAR message, or both. If a network entity 105 receives multiple WUS from multiple UEs 115, the network entity 105 may dynamically adjust timing information for PDCCH windows of the UEs 115 to avoid resource conflicts. For example, the network entity 105 may adjust a PDCCH window start time or duration or a slot aggregation parameter for one or more of the UEs 115.

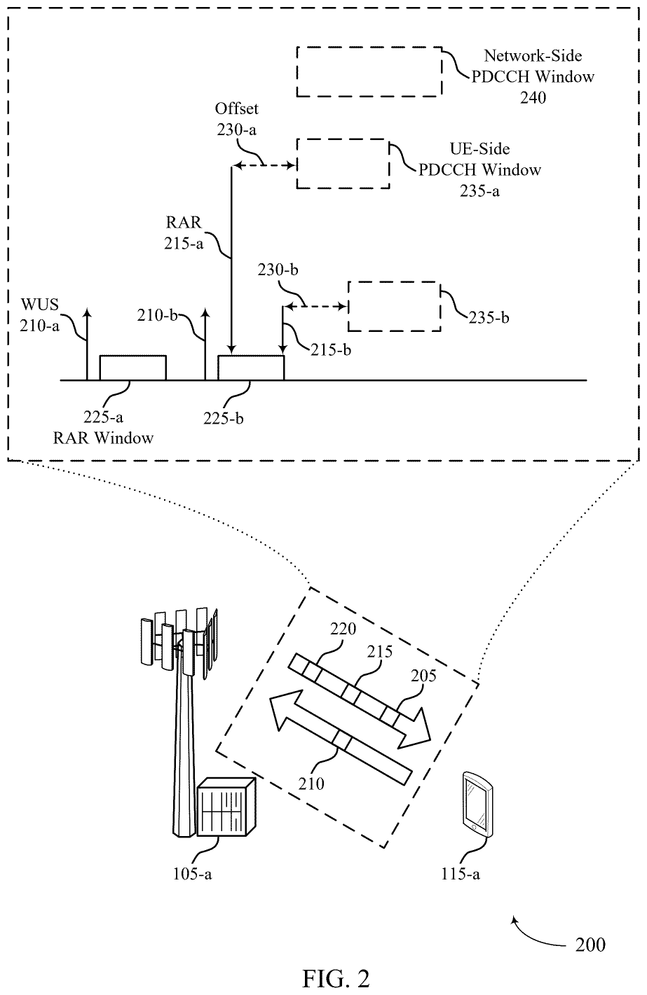

FIG. 2 shows an example of a wireless communications system 200 that supports downlink control channel monitoring occasion configuration for on-demand system information in accordance with one or more aspects of the present disclosure.

The wireless communications system 200 may include aspects of a wireless communications system 100. For example, the wireless communications system 200 includes a UE 115-a and a network entity 105-a, which may be respective examples of a UE 115 and a network entity 105 described herein.

The wireless communications system 200 may support techniques for on-demand system information, such as an on-demand SIB1. The network entity 105-a may transmit a control signal indicating an uplink WUS configuration 205 to the UE 115-a. The UE 115-a may transmit an uplink WUS 210 to the network entity 105-a. The uplink WUS 210 may trigger or request an on-demand SIB1 220. In some examples, the UE 115-a may transmit the uplink WUS via a random access occasion. The network entity 105-a may transmit an RAR message 215 in response to the uplink WUS 210, which may configure the UE 115-a to monitor for the on-demand SIB1 220. The network entity 105-a may transmit the on-demand SIB1 220 to the UE 115-a during a PDCCH window 235.

For example, the UE 115-a may transmit a WUS 210-a during a first random access occasion. The UE 115-a may monitor for an RAR message 215 in an RAR window 225-a. In this case, the UE 115-a may not receive an RAR message 215 in the RAR window 225-a. At a second random access occasion, the UE 115-a may transmit a WUS 210-b and monitor an RAR window 225-b for an RAR message 215. In this case, the UE 115-a may receive an RAR message 215 during the RAR window 225-b.

The RAR message 215 received during the RAR window 225-b may configure the UE 115-a to monitor for the on-demand SIB1 220 during a PDCCH window 235 that is offset from a reference time point. In some examples, the reference time point may be indicated via the uplink WUS configuration or the RAR message 215. In some cases, the reference time point may be statically configured (e.g., for the UE 115 or the wireless communications system 200) or specified in a technical specification. In some examples, the time offset may be indicated via the uplink WUS configuration or the RAR message 215. In some cases, the time offset may be statically configured (e.g., for the UE 115 or the wireless communications system 200) or standardized. For example, the time offset may be statically configured based on a PDSCH processing latency for RAR messages 215.

In some examples, the reference time point may correspond to a reception time of the RAR message 215. In some cases, a same time offset may be used for different RAR messages, where a time offset 230-a and a time offset 230-b may be a same duration or length of time. For example, a first RAR message 215-a transmitted early in the RAR window 225-b may have a same length offset as a second RAR message 215-b transmitted later in the RAR window 225-b, such that a first UE-side PDCCH window 235-a corresponding to the first RAR message 215-a begins earlier than a second UE-side PDCCH window 235-b corresponding to the second RAR message 215-b. In this case, the network entity 105-a may transmit on-demand SIB1s in a larger, network-side PDCCH window 240, as the network-side PDCCH window 240 may have a duration equal to a union of all UE-side PDCCH windows 235. This example may provide lower latency, but uses higher network energy consumption.

In some examples, the reference time point may correspond to a transmission time of the uplink WUS. The UE 115-a may wait for the RAR message to determine whether to retransmit the uplink WUS, as an initial transmission of an uplink WUS may not be successfully received. For example, the UE 115-a did not receive an RAR message 215 in response to the uplink WUS 210-a. Therefore, using the transmission time of the uplink WUS 210 may, in some cases, be less reliable than configuring the PDCCH window 235 to be based on timing information of the RAR message 215 or the RAR window 225.

In some examples, the reference time point may be based on the RAR window 225. For example, the reference time point may be based on an end of the RAR window 225 instead of a receipt of a specific RAR message within the RAR window 225. In this example, both the network-side and the UE-side PDCCH monitoring windows may be aligned.

The wireless communications system 200 may support techniques to align UE-side and network-side PDCCH windows by configuring a start time and a duration of a PDCCH window for on-demand system information, such as on-demand SIB1. In some examples, a starting time or a duration of the PDCCH window may be indicated in the RAR message that is response to the uplink WUS. Additionally, or alternatively, the starting time or the duration of the PDCCH window may be indicated in the uplink WUS configuration.

For example, the UE 115-a may receive the first RAR message 215-a during the RAR window 225-b. A reference time point may be indicated by the uplink WUS configuration 205 or the first RAR message 215-a, or the reference time point may be statically configured (e.g., specified in a technical specification). The uplink WUS configuration or the first RAR message 215-a may indicate a time offset 230 from the reference time point to a PDCCH window 235, or the time offset 230 may be statically configured (e.g., specified in a technical specification). The uplink WUS configuration or the first RAR message 215-a may indicate a duration of the PDCCH window 235 from the reference time point, or the duration of the PDCCH window 235 may be statically configured (e.g., specified in a technical specification). The UE 115-a may monitor the PDCCH window 235 for the on-demand SIB1 220 after the time offset 230 from the reference point.

In some examples, the PDCCH window 235 may start right after the time offset 230 from a reference time. For example, the UE-side PDCCH window 235-b is shown to begin right after the time offsets 230-b from the reference time point. The PDCCH window 235 may or may not align with a Type-0 PDCCH occasion associated with the uplink WUS occasion. A duration of the PDCCH window 235 may be based on a target quantity of on-demand SIB1 transmissions and a maximum time offset to the earliest associated Type-0 PDCCH occasion.

In some examples, a beginning of the PDCCH window 235 may align with a corresponding Type-0 PDCCH occasion. A UE 115-a may receive a first SSB and transmit the uplink WUS 210-b to a serving cell in a random access occasion corresponding to the first SSB. The serving cell may transmit an RAR message 215 to the UE 115-a in response to the uplink WUS 210-b to configure the UE 115-a to monitor for an on-demand SIB1 in a PDCCH window after a time offset 230 from a reference time point. A beginning of the PDCCH window may align with an earliest Type-0 PDCCH occasion corresponding to the first SSB after the time offset 230. A duration of the PDCCH window 235 may be based on a target quantity of SIB1 transmissions.

The starting time and/or duration of the PDCCH window for the on-demand system information (e.g., on-demand SIB1) may be indicated semi-statically via the uplink WUS configuration, dynamically by the RAR message, statically configured, or any combination thereof. The starting time may be indicated based on an offset from a reference time point. For example, the PDCCH monitoring window may begin right after the offset from the reference time point, or a starting boundary of the PDCCH monitoring window may align with a corresponding PDCCH occasion, as described herein.

In some examples, the starting time may align with a slot or symbol boundary. The slot or symbol may be defined based on a downlink default SCS, specified via a MIB, or based on an SCS indicated via the uplink WUS configuration 205. In some examples, the duration of the PDCCH window may be defined as a quantity of milliseconds, a quantity of slots, or a quantity of SSB periods. A slot of the quantity of slots may be based on the downlink default SCS (e.g., specified via the MIB) or based on an SCS indicated via the uplink WUS configuration 205.

The reference point may be based on a received RAR message 215, such as based on a time of receipt for the RAR message 215, or based on an RAR window 225 with the received RAR message 215. In some examples, the reference time point may be statically configured or standardized. In some examples, different types of reference time points may be defined based on a message type indicating the starting time. For example, the reference time point is based on the received RAR message 215 if the starting time is dynamically indicated by the received RAR message 215. In some other examples, the reference time point may be based on the RAR window if the starting time is semi-statically configured by the uplink WUS configuration 205. In some examples, the reference time point may be indicated by the uplink WUS configuration 205 or the RAR message 215, or both, to select between using the received RAR message 215 and the RAR window 225 as the reference time point.

For example, an RAR message 215 may indicate one or more parameters including a starting time of a PDCCH window 235 or a duration of the PDCCH window 235. In some examples, a parameter indicated by the RAR message 215 may be an actual value of the parameter. For example, the RAR message 215 may indicate an explicit value for a starting time of the PDCCH window, a delay between a time offset 230 and a start of the PDCCH window, or both. Additionally, or alternatively, the RAR message 215 may indicate an explicit value for a duration of the PDCCH window, such as a quantity of slots, symbols, or SSB periods. The value indicated by the RAR message may override or replace a value configured by the uplink WUS configuration 205 or a statically configured or standardized value.

In some examples, the RAR message 215 may indicate a parameter by indicated an index to a list of values. For example, the uplink WUS configuration 205 may configure a list of values for the parameter, and the RAR message 215 may select one value from the list of values for the parameter. Additionally, or alternatively, the list of values for the parameter for may be statically configured or specified in a technical specification.

In some examples, the RAR message 215 may indicate a parameter by indicating a delta value or a differential from another parameter value. For example, the RAR message 215 may indicate a delta value to apply and adjust a parameter value configured by the uplink WUS configuration 205 or a statically configured, or standardized, parameter value.

In some examples, parameters may be indicated by the RAR message 215, the uplink WUS configuration, or a static configuration, or any combination thereof. For example, the reference time point may be statically configured (e.g., specified in a technical specification), the duration of the PDCCH window 235 may be semi-statically configured by the uplink WUS configuration 205, and the starting time of the PDCCH window 235 may be indicated by the RAR message 215. Additionally, or alternatively, the reference time point may be statically configured, the starting time and duration of the PDCCH window 235 may be semi-statically configured by the uplink WUS configuration 205, and the starting time and duration of the PDCCH window may be optionally indicated or updated by the RAR message 215.

In some examples, different RAR message 215 within a same RAR window may carry the same or different parameters. For example, the first RAR message 215-a and the second RAR message 215-b may each be transmitted within the RAR window 225-b, and these RAR message 215 may indicate the same or different parameters. For example, if the reference time point is based on the received RAR message 215, the network entity 105 may indicate different starting offsets in different RAR messages such that the starting time of the PDCCH windows 235 for the UEs 115 are aligned (e.g., regardless of which RAR message 215 is received by which UE 115). In some other examples, if the reference time point is based on the received RAR message 215, the network entity 105 may indicate the same time offset 230 in different RAR messages 215 such that each UE 115 can acquire the on-demand SIB1 as soon as possible after the received RAR message 215.

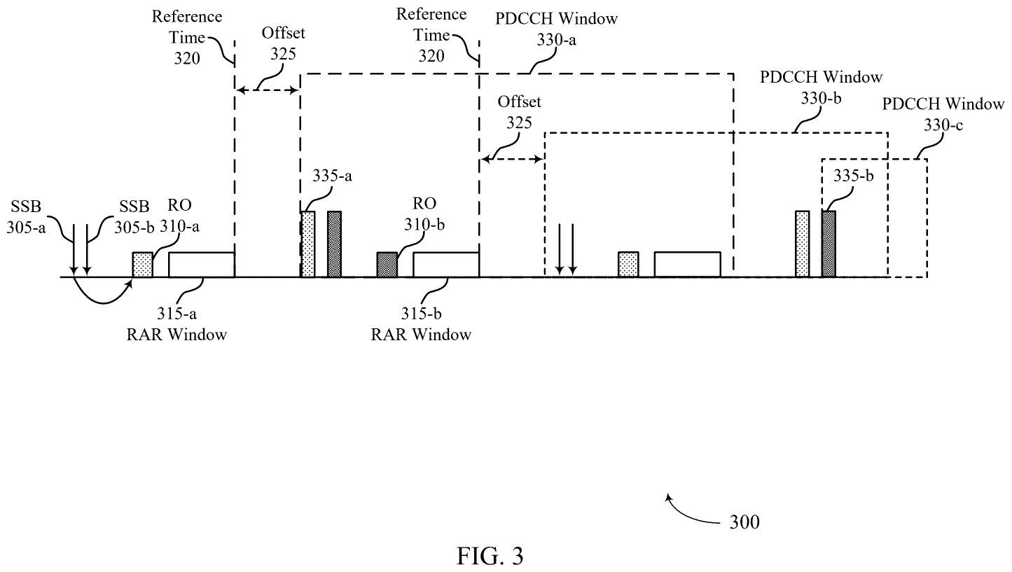

FIG. 3 shows an example of a PDCCH window alignment configuration 300 that supports downlink control channel monitoring occasion configuration for on-demand system information in accordance with one or more aspects of the present disclosure.

A network entity 105 may configure a UE 115 with an uplink WUS configuration, and the UE 115 may transmit an uplink WUS to request on-demand system information, such as an on-demand SIB1. The network entity 105 may periodically transmit an SSB burst, and the UE 115 may receive an SSB 305. For example, the UE 115-a may receive an SSB 305-a. The UE 115 may transmit the uplink WUS via a random access occasion 310 associated with the SSB 305. For example, the random access occasion 310-a may be associated with the SSB 305-a.

The UE 115 may monitor an RAR window 315 for an RAR message in response to the uplink WUS. For example, the UE 115 may monitor an RAR window 315-a after transmitting the uplink WUS via the random access occasion 310-a. The RAR message may configure the UE 115 to monitor for on-demand SIB1 transmission in a PDCCH window 330-a. For example, the UE 115 may monitor a PDCCH occasion, such as a Type-0 PDCCH occasion, that corresponds to the received SSB 305 for a downlink control information grant that schedules a PDSCH. The network entity 105 may transmit the on-demand SIB1 via the PDSCH.

Timing information, such as a starting time of a PDCCH window, duration of the PDCCH window, a reference time point, and a timing offset from the reference time point, or any combination thereof, may be indicated via the uplink WUS configuration or the RAR message, or both. Additionally, or alternatively, some parameters of the timing information may be statically configured or specified in a technical specification.

For example, a PDCCH window 330-a may be offset from a reference time 320 by a time offset 325. The PDCCH window 330-a may begin right after the time offset 325 from the reference time 320. In this example, the PDCCH window 330-a may align with a PDCCH occasion 335-a that corresponds to the received SSB 305-a. A duration of the PDCCH window 330-a may be configured based on a target quantity of on-demand SIB1 transmissions and a maximum time offset to the earliest PUCCH occasion 335 that corresponds to the received SSB 305.

In another example, a UE 115 may receive the SSB 305-b. The UE 115 may transmit a WUS via a random access occasion 310-b and monitor for an RAR message in an RAR window 315-b. In some examples, the UE 115 may begin monitoring during a PDCCH window 330-b. The PDCCH window 330-b may start right after the timing offset 325 from the reference time 320, which is the end of the RAR window 315-b in this example. The PDCCH window 330-b may not align with a beginning of a PDCCH occasion 335-b, or the earliest PDCCH occasion that corresponds to the SSB 305-b. In some other examples, the UE 115 may begin monitoring during a PDCCH window 330-c. The PDCCH window 330-c may be aligned with an earliest corresponding Type-0 PDCCH occasion. For example, the PDCCH window 330-c may be aligned with the beginning of the PDCCH occasion 335-b. Timing information indicated by the uplink WUS configuration, the RAR message, or statically configured may determine whether the UE 115 monitors the PDCCH window 330-b or the PDCCH window 330-c when receiving the SSB 305-b.

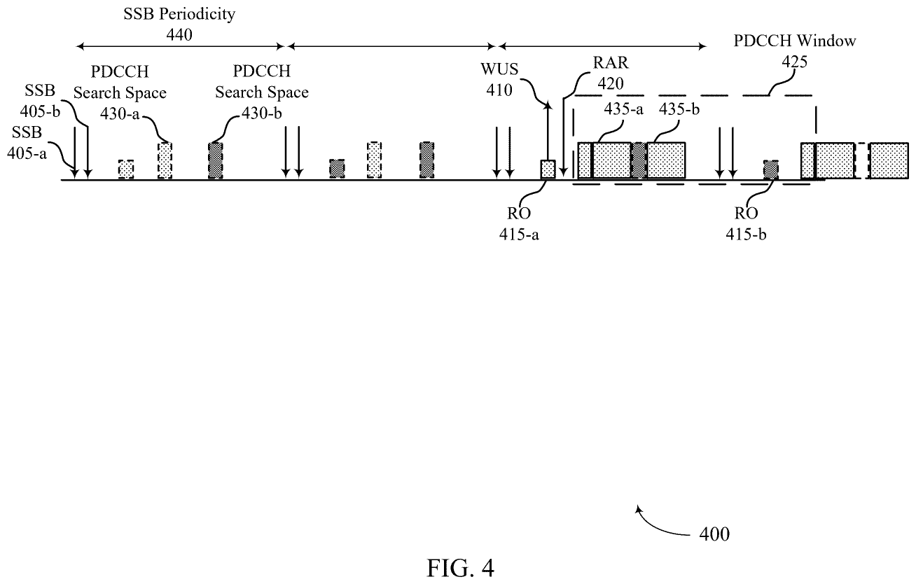

FIG. 4 shows an example of a slot aggregation configuration 400 that supports downlink control channel monitoring occasion configuration for on-demand system information in accordance with one or more aspects of the present disclosure.

A wireless communications system may support techniques for slot aggregation of on-demand SIB1. PDSCH slot aggregation may be used to transmit repeated SIB1s in consecutive slots to reduce SIB1 acquisition latency and save power consumption for both a network entity 105 and a UE 115. A slot aggregation parameter may be semi-statically indicated via an uplink WUS configuration or dynamically indicated via an RAR message, or both. If a network entity 105 receives multiple WUS from multiple UEs 115, the network entity 105 may dynamically adjust timing information for PDCCH windows of the UEs 115 to avoid resource conflicts. For example, the network entity 105 may adjust a PDCCH window start time or duration or a slot aggregation parameter for one or more of the UEs 115.

For example, a UE 115 may receive a first SSB 405-a and transmit an uplink WUS 410 during a random access occasion 415-a. The random access occasion 415-a may be associated with the first SSB 405-a, while some other random access occasions 415 are associated with other SSBs. For example, if the UE 115 received a second SSB 405-b, the UE 115 may transmit the uplink WUS 410 to a network entity 105 during a random access occasion 415-b associated with the second SSB 405-b and monitor for SIB1 signaling based on a PDCCH occasion 430-b associated with the second SSB 405-b. The network entity 105 may transmit an RAR message 420 in response to the uplink WUS 410.

The RAR message 420 or an uplink WUS configuration, or both, may indicate timing information or timing parameters as described herein. For example, the RAR message 420 or the uplink WUS configuration, or both, may indicate a reference time point, a time offset, a start duration of a PDCCH window 425, a duration of the PDCCH window 425, or any combination thereof.

The network entity 105 may use slot aggregation to transmit repeated SIB1s in consecutive slots. For example, the network entity 105 may indicate a slot aggregation parameter via the RAR message 420 or the uplink WUS configuration, or both. In some examples, the slot aggregation parameter may be statically configured or specified in a technical specification. For example, the network entity 105 may indicate a slot aggregation parameter K to the UE 115, where K is set to 2, 4, or 8, or another quantity. In some cases, if the UE 115 is not configured with a slot aggregation parameter, the network entity 105 may not utilize slot aggregation.

The UE 115 may begin monitoring a PDCCH search space during a PDCCH occasion 430 in the PDCCH window 425. For example, the UE 115 may monitor for PDCCH signaling during a PDCCH occasion 430-a, which is associated with the received SSB (e.g., the first SSB 405-a). The UE 115 may receive a grant that schedules a PDSCH slot aggregation for transmission of a SIB1 435 over consecutive slots based on the slot aggregation parameter. For example, if the slot aggregation parameter is set to K=2, the UE 115 may receive two SIB1s 435 (e.g., a SIB1 435-a and a SIB1 435-b) in two consecutive slots.

When using slot aggregation, a duration of the PDCCH window 425 may be based on a target quantity of SIB1s. For example, the UE 115 may be at a cell edge of the network entity 105, and the UE 115 may require combining N repetitions of a SIB1 435 to decode the SIB1. In some examples, the repetition factor, K, may be set to be larger than or equal to N. The PDCCH window duration may be set to a quantity of repeated SIB1s required for the UE 115 times a SIB1 transmission repetition periodicity 440.

In some systems, a network entity 105 may transmit SIB1s mapped to a same SSB that correspond to a requesting uplink WUS. Using slot aggregation, the network entity 105 may transmit repeated SIB1s 435 in consecutive slots to reduce SIB1 acquisition latency and save power consumption.

In some cases, the wireless communications system may support additional, or alternative, techniques for a UE 115 to receive multiple on-demand SIB1s within a PDCCH window without using slot aggregation. For example, a duration of the PDCCH window may be configured to be large enough for the UE 115 to receive a target quantity of repeated SIB1s based on an SNR of the UE 115. For example, the PDCCH window duration may be configured to be equal to the target quantity of repeated SIB1s times the SIB1 transmission repetition periodicity. If, for example, the UE 115 can decode the SIB1 by combining four repetitions of the SIB1, and the SIB1 transmission repetition periodicity is 20 milliseconds long, the PDCCH window may be configured to be at least 80 milliseconds long.

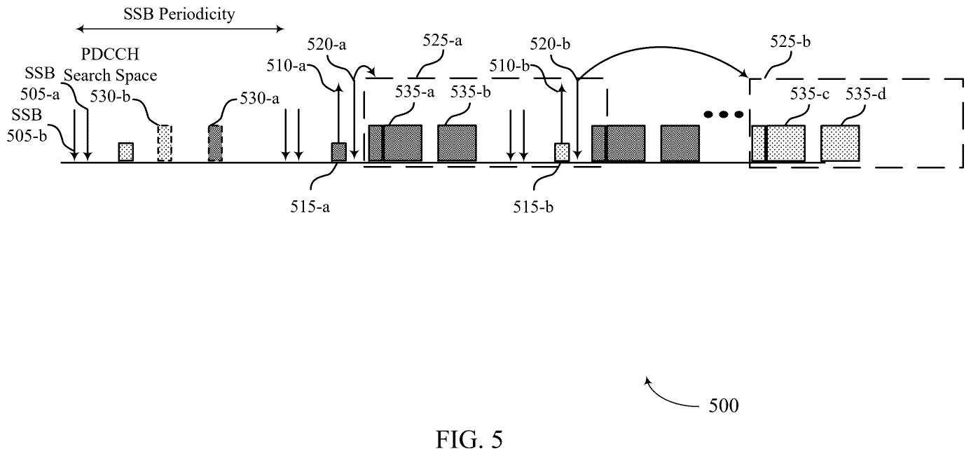

FIG. 5 shows an example of a multiple UE slot aggregation configuration 500 that supports downlink control channel monitoring occasion configuration for on-demand system information in accordance with one or more aspects of the present disclosure.

A wireless communications system may support techniques for slot aggregation of on-demand SIB1. PDSCH slot aggregation may be used to transmit repeated SIB1s in consecutive slots to reduce SIB1 acquisition latency and save power consumption for both a network entity 105 and a UE 115. A slot aggregation parameter may be semi-statically indicated via an uplink WUS configuration or dynamically indicated via an RAR message, or both. If a network entity 105 receives multiple WUS from multiple UEs 115, the network entity 105 may dynamically adjust timing information for PDCCH windows of the UEs 115 to avoid resource conflicts. For example, the network entity 105 may adjust a PDCCH window start time or duration or a slot aggregation parameter for one or more of the UEs 115.

The multiple UE slot aggregation configuration 500 may include aspects of a slot aggregation configuration 400 as described with reference to FIG. 4. For example, a first UE 115 may receive a first SSB 505-a, transmit a first WUS 510-a during a first random access occasion 515-a, and receive a first RAR message 520-a in response to the first WUS 510-a. The first RAR message 520-a may configure the first UE 115 to monitor a first PDCCH window 525-a. Timing information for the first PDCCH window 525-a, including a reference time, a time offset, a start time of the first PDCCH window 525-a, or a duration of the first PDCCH window 525-a, may be configured at the first UE 115 via an uplink WUS configuration, the first RAR message 520-a, or via a static configuration. The UE 115 may be configured with a slot aggregation parameter, and the UE 115 may monitor a PDCCH occasion 530-a, associated with the first SSB 505-a, for a grant that schedules PDSCH resources for multiple SIB1s (e.g., a first SIB1 535-a and a second SIB1 535-b).

The network entity 105 may also receive a second WUS from a second UE 115. For example, the network entity 105 may receive a second WUS 510-b during a second random access occasion 515-b. The first WUS 510-a may be associated with the first SSB 505-a, and the second WUS 510-b may be associated with the second SSB 505-b and a PDCCH occasion 530-b. If the network entity 105 receives requests for on-demand SIB1 from multiple UEs 115 associated with different SSBs 505, the network entity 105 may avoid resource conflict when using PDSCH slot aggregation for on-demand SIB1 by dynamically adjusting timing information of PDCCH windows 525. For example, the network entity 105 may dynamically adjust a starting offset of a PDCCH window 525-b, a slot aggregation parameter for the second UE, a duration of the PDCCH window 525-b, or any combination thereof via an RAR message 520-b to the second UE. The network entity 105 may transmit multiple SIB1s, including SIB1 535-c and SIB1 535-d, to the second UE 115 in the PDCCH window 525-b based on the timing information for the PDCCH window 525-b.

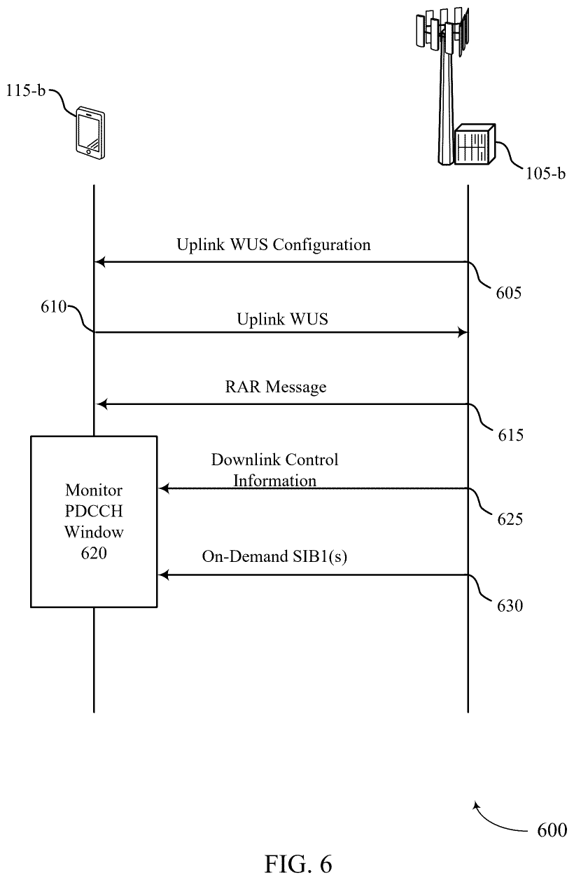

FIG. 6 shows an example of a process flow 600 that supports downlink control channel monitoring occasion configuration for on-demand system information in accordance with one or more aspects of the present disclosure. In some examples, the process flow 600 may implement or be implemented by aspects of the wireless communications system 100, the wireless communications system 200, or both as described with reference to FIGS. 1 and 2. For example, the process flow 600 may include a UE 115-b and a network entity 105-b, which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 600, some aspects of some operations may also be performed by one or more other wireless devices.

At 605, the network entity 105-b may transmit a control signal indicating an uplink WUS configuration for on-demand SIB1 that is triggered by an uplink WUS to the UE 115-b. In some examples, the uplink WUS configuration may include an indication of a start time, a duration, or both, of a PDCCH window. In some examples, the uplink WUS configuration may include a configuration for a reference time point.

At 610, the UE 115-b may transmit an uplink WUS to the network entity 105-b. The UE 115-b may transmit the uplink WUS during a random access occasion. The uplink WUS may request on-demand system information from the network entity 105-b, such as on-demand SIB1.

At 615, the UE 115-b may receive, during an RAR window, an RAR message based on the uplink WUS. In some examples, the UE 115-b may receive an indication of the start time, the duration, or both, of the PDCCH window from the RAR message. In some examples, the RAR message may indicate one or more values, an index to a list of values, one or more delta values, or any combination thereof, to indicate the start time or the duration, or both.

At 620, the UE 115-b may monitor during a PDCCH window for one or more on-demand SIBs. The UE 115-b may monitor during the PDCCH window based on the RAR message. The PDCCH window may include a start time and a duration. In some examples, the start time and the duration may be indicated via the uplink WUS configuration or the RAR message, or both. Additionally, or alternatively, the start time and the duration may be statically configured or specified in a technical specification.

In some examples, the start time of the PDCCH window occurs after a time offset from a reference point. In some examples, the start time of the PDCCH window aligns with a start of an earliest PDCCH occasion after the time offset based on an index of a received SSB. In some examples, the PDCCH window may start right after the end of the time offset. The reference time point may correspond to the RAR window or a time of reception of the RAR message. In some examples, the reference time point may be statically configured or specified in a technical specification. Additionally, or alternatively, the uplink WUS configuration or the RAR message, or both, may indicate or update the reference time point.

In some examples, the duration of the physical downlink control channel window may correspond to a first quantity of milliseconds, a second quantity of slots, a third quantity of synchronization signal block periods, or any combination thereof. The second quantity of slots may be based on a first downlink SCS indicated by a MIB or a second downlink SCS indicated by the uplink WUS configuration. In some examples, the start time may correspond to a slot boundary or a symbol boundary based on a first downlink SCS indicated by a MIB or a second downlink SCS indicated by the uplink WUS configuration.

For example, at 625, the network entity 105-b may transmit downlink control information to the UE 115-b. The downlink control information may be, or may include, a grant for PDSCH resources. At 630, the network entity 105-b may transmit one or more on-demand SIB1s to the UE 115-b via the PDSCH resources.

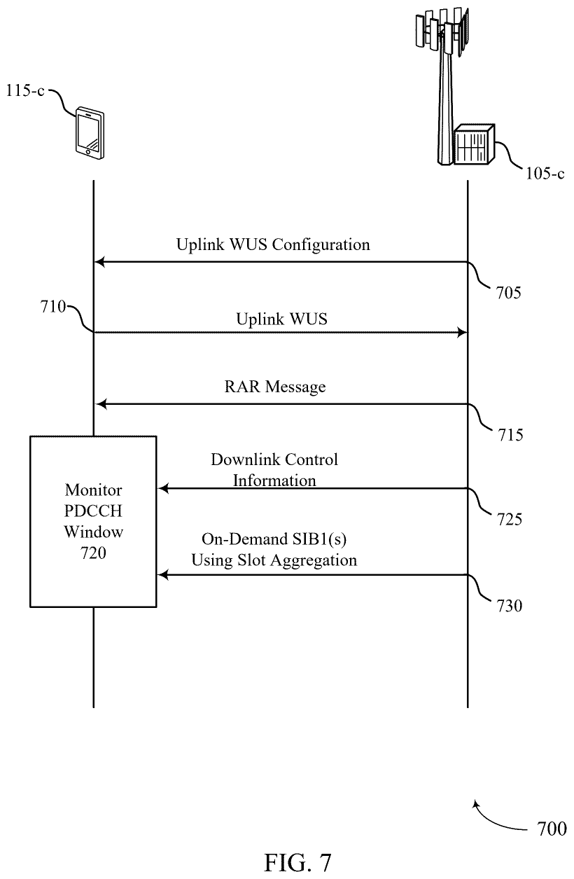

FIG. 7 shows an example of a process flow 700 that supports downlink control channel monitoring occasion configuration for on-demand system information in accordance with one or more aspects of the present disclosure. In some examples, the process flow 700 may implement or be implemented by aspects of the wireless communications system 100, the wireless communications system 200, or both as described with reference to FIGS. 1 and 2. For example, the process flow 700 may include a UE 115-c and a network entity 105-c, which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the UE 115-c and the network entity 105-c are shown performing the operations of the process flow 700, some aspects of some operations may also be performed by one or more other wireless devices.

At 705, the network entity 105-c may transmit a control signal indicating an uplink WUS configuration for on-demand SIB1 that is triggered by an uplink WUS to the UE 115-c. In some examples, the uplink WUS configuration may include an indication of a start time, a duration, or both, of a PDCCH window. In some examples, the uplink WUS configuration may include a configuration for a reference time point.

At 710, the UE 115-c may transmit an uplink WUS to the network entity 105-c. The UE 115-c may transmit the uplink WUS during a random access occasion.

The uplink WUS may request on-demand system information from the network entity 105-c, such as on-demand SIB1.

At 715, the UE 115-c may receive, during an RAR window, an RAR message based on the uplink WUS. In some examples, the UE 115-c may receive an indication of the start time, the duration, or both, of the PDCCH window from the RAR message. In some examples, the RAR message may indicate one or more values, an index to a list of values, one or more delta values, or any combination thereof, to indicate the start time or the duration, or both.

At 720, the UE 115-c may monitor during a PDCCH window for multiple SIB1s based on a slot aggregation parameter. For example, the UE 115-c may monitor a set of PDCCH monitoring occasions for a respective set of SIB1s based on the slot aggregation parameter. The slot aggregation parameter may be indicated via the uplink WUS configuration or the RAR message, or both. In some examples, the slot aggregation parameter may be statically configured for specified in a technical specification.

In some examples, the UE 115-c may monitor multiple PDCCH monitoring occasions across multiple SIB1 transmission repetition periods. A PDCCH window may include multiple SIB1 transmission repetition periods.

In some examples, the UE 115-c may receive a PDCCH signal scheduling a grant in a first PDCCH monitoring occasion within a PDCCH window at 725. The grant may schedule a PDSCH slot aggregation for transmission of a SIB, such as a SIB1, over consecutive slots based on the slot aggregation parameter. The network entity 105-c may transmit, during the PDCCH occasions, a respective set of SIB1s based on the slot aggregation parameter indicated via the WUS configuration or the RAR message, or both.

The UE 115-c may monitor during the PDCCH window based on the RAR message. The PDCCH window may include a start time and a duration. In some examples, the start time and the duration may be indicated via the uplink WUS configuration or the RAR message, or both. Additionally, or alternatively, the start time and the duration may be statically configured or specified in a technical specification.

In some examples, the start time of the PDCCH window occurs after a time offset from a reference point. In some examples, the start time of the PDCCH window aligns with a start of an earliest PDCCH occasion after the time offset based on an index of a received SSB. In some examples, the PDCCH window may start right after the end of the time offset. The reference time point may correspond to the RAR window or a time of reception of the RAR message. In some examples, the reference time point may be statically configured or specified in a technical specification. Additionally, or alternatively, the uplink WUS configuration or the RAR message, or both, may indicate or update the reference time point.

In some examples, the duration of the physical downlink control channel window may correspond to a first quantity of milliseconds, a second quantity of slots, a third quantity of synchronization signal block periods, or any combination thereof. The second quantity of slots may be based on a first downlink SCS indicated by a MIB or a second downlink SCS indicated by the uplink WUS configuration. In some examples, the start time may correspond to a slot boundary or a symbol boundary based on a first downlink SCS indicated by a MIB or a second downlink SCS indicated by the uplink WUS configuration.

For example, at 725, the network entity 105-c may transmit downlink control information to the UE 115-c. The downlink control information may be, or may include, a grant for PDSCH resources. At 730, the network entity 105-c may transmit one or more on-demand SIB1s to the UE 115-c via the PDSCH resources.

In some examples, the network entity 105-c may receive uplink WUS from different UEs based on different SSBs. To avoid resource confliction based on slot aggregation for one UE 115, the network entity 105-c may update timing information of a PDCCH window at another UE 115. For example, the network entity 105-c may output, during a second RAR window, a second RAR message based on a second uplink WUS. The RAR message transmitted at 715 may indicate first timing information (e.g., start time and duration) for a first PDCCH window, and the second RAR message may indicate second timing information (e.g., start time and duration) for a second PDCCH window.

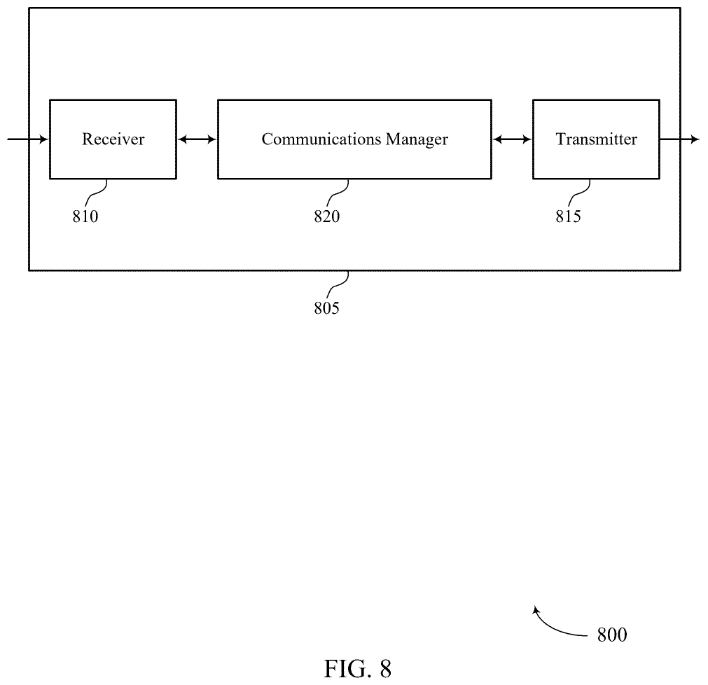

FIG. 8 shows a block diagram 800 of a device 805 that supports downlink control channel monitoring occasion configuration for on-demand system information in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to downlink control channel monitoring occasion configuration for on-demand system information). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to downlink control channel monitoring occasion configuration for on-demand system information). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of downlink control channel monitoring occasion configuration for on-demand system information as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a control signal indicating an uplink WUS configuration for on-demand SIB1 that is triggered by an uplink WUS. The communications manager 820 is capable of, configured to, or operable to support a means for receiving, during an RAR window, an RAR message based on the uplink WUS. The communications manager 820 is capable of, configured to, or operable to support a means for monitoring, based on the RAR message and during a physical downlink control channel window, for one or more on-demand SIBs, where the physical downlink control channel window includes a start time and a duration.

Additionally, or alternatively, the communications manager 820 may support wireless communications in accordance with examples as disclosed herein. For example, the communications manager 820 is capable of, configured to, or operable to support a means for receiving a control signal indicating an uplink WUS configuration for on-demand SIB1 that is triggered by an uplink WUS. The communications manager 820 is capable of, configured to, or operable to support a means for receiving, during an RAR window, an RAR message based on the uplink WUS. The communications manager 820 is capable of, configured to, or operable to support a means for monitoring a set of multiple physical downlink control channel monitoring occasions for a respective set of multiple SIBs based on a slot aggregation parameter indicated via the uplink WUS configuration or the RAR message, or both.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

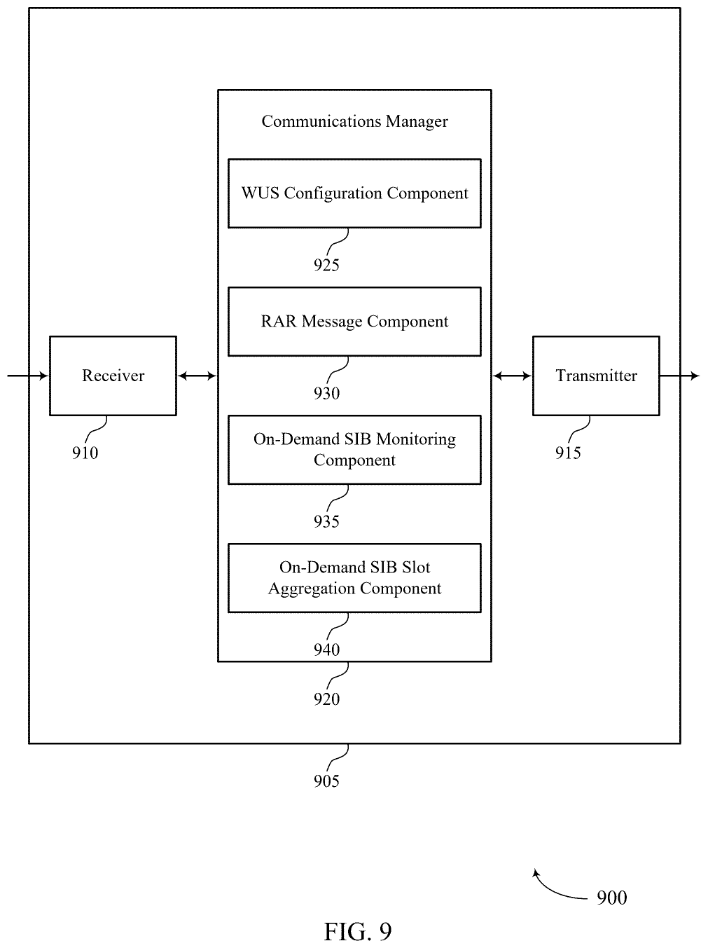

FIG. 9 shows a block diagram 900 of a device 905 that supports downlink control channel monitoring occasion configuration for on-demand system information in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to downlink control channel monitoring occasion configuration for on-demand system information). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to downlink control channel monitoring occasion configuration for on-demand system information). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of downlink control channel monitoring occasion configuration for on-demand system information as described herein. For example, the communications manager 920 may include a WUS configuration component 925, an RAR message component 930, an on-demand SIB monitoring component 935, an on-demand SIB slot aggregation component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The WUS configuration component 925 is capable of, configured to, or operable to support a means for receiving a control signal indicating an uplink WUS configuration for on-demand SIB1 that is triggered by an uplink WUS. The RAR message component 930 is capable of, configured to, or operable to support a means for receiving, during an RAR window, an RAR message based on the uplink WUS. The on-demand SIB monitoring component 935 is capable of, configured to, or operable to support a means for monitoring, based on the RAR message and during a physical downlink control channel window, for one or more on-demand SIBs, where the physical downlink control channel window includes a start time and a duration.

Additionally, or alternatively, the communications manager 920 may support wireless communications in accordance with examples as disclosed herein. The WUS configuration component 925 is capable of, configured to, or operable to support a means for receiving a control signal indicating an uplink WUS configuration for on-demand SIB1 that is triggered by an uplink WUS. The RAR message component 930 is capable of, configured to, or operable to support a means for receiving, during an RAR window, an RAR message based on the uplink WUS. The on-demand SIB slot aggregation component 940 is capable of, configured to, or operable to support a means for monitoring a set of multiple physical downlink control channel monitoring occasions for a respective set of multiple SIBs based on a slot aggregation parameter indicated via the uplink WUS configuration or the RAR message, or both.

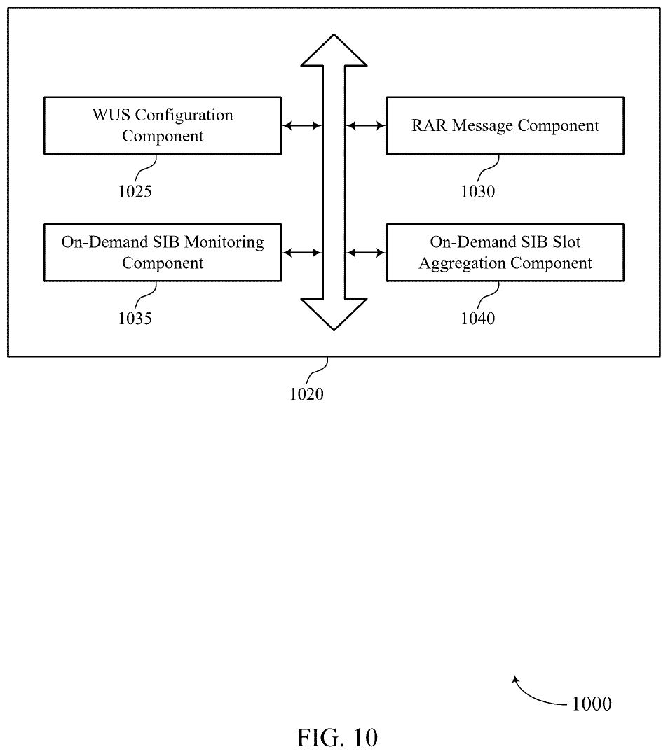

FIG. 10 shows a block diagram 1000 of a communications manager 1020 that supports downlink control channel monitoring occasion configuration for on-demand system information in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of downlink control channel monitoring occasion configuration for on-demand system information as described herein. For example, the communications manager 1020 may include a WUS configuration component 1025, an RAR message component 1030, an on-demand SIB monitoring component 1035, an on-demand SIB slot aggregation component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The WUS configuration component 1025 is capable of, configured to, or operable to support a means for receiving a control signal indicating an uplink WUS configuration for on-demand SIB1 that is triggered by an uplink WUS. The RAR message component 1030 is capable of, configured to, or operable to support a means for receiving, during an RAR window, an RAR message based on the uplink WUS. The on-demand SIB monitoring component 1035 is capable of, configured to, or operable to support a means for monitoring, based on the RAR message and during a physical downlink control channel window, for one or more on-demand SIBs, where the physical downlink control channel window includes a start time and a duration.

In some examples, the WUS configuration component 1025 is capable of, configured to, or operable to support a means for receiving an indication of the start time, the duration, or both, from the uplink WUS configuration.

In some examples, the RAR message component 1030 is capable of, configured to, or operable to support a means for receiving an indication of the start time, the duration, or both, from the RAR message.

In some examples, the RAR message indicates one or more values, an index to a list of values, one or more delta values, or any combination thereof, to indicate the start time or the duration, or both.

In some examples, the start time of the physical downlink control channel window occurs after a time offset from a reference time point.

In some examples, the start time of the physical downlink control channel window aligns with a start of an earliest downlink control channel occasion after the time offset based on an index of a received synchronization signal block.

In some examples, the reference time point corresponds to the RAR window or a time of reception of the RAR message.

In some examples, the reference time point is configured via a static configuration, the uplink WUS configuration, the RAR message, or any combination thereof.

In some examples, the time offset is specified in a technical specification based on a physical downlink shared channel processing latency for the RAR message.

In some examples, the reference time point is specified in a technical specification.

In some examples, the start time corresponds to a slot boundary or a symbol boundary based on a first downlink subcarrier spacing indicated by a master information block or a second downlink subcarrier spacing indicated by the uplink WUS configuration.

In some examples, the duration of the physical downlink control channel window corresponds to a first quantity of milliseconds, a second quantity of slots, a third quantity of synchronization signal block periods, or any combination thereof. In some examples, the second quantity of slots is based on a first downlink subcarrier spacing indicated by a master information block or a second downlink subcarrier spacing indicated by the uplink WUS configuration.

Additionally, or alternatively, the communications manager 1020 may support wireless communications in accordance with examples as disclosed herein. In some examples, the WUS configuration component 1025 is capable of, configured to, or operable to support a means for receiving a control signal indicating an uplink WUS configuration for on-demand SIB1 that is triggered by an uplink WUS. In some examples, the RAR message component 1030 is capable of, configured to, or operable to support a means for receiving, during an RAR window, an RAR message based on the uplink WUS. The on-demand SIB slot aggregation component 1040 is capable of, configured to, or operable to support a means for monitoring a set of multiple physical downlink control channel monitoring occasions for a respective set of multiple SIBs based on a slot aggregation parameter indicated via the uplink WUS configuration or the RAR message, or both.

In some examples, to support monitoring the set of multiple physical downlink control channel monitoring occasions, the on-demand SIB slot aggregation component 1040 is capable of, configured to, or operable to support a means for monitoring the set of multiple physical downlink control channel monitoring occasions across a set of multiple SIB transmission repetition periods, where a physical downlink control channel monitoring window includes the set of multiple SIB transmission repetition periods.

In some examples, the on-demand SIB slot aggregation component 1040 is capable of, configured to, or operable to support a means for receiving a physical downlink control channel signal scheduling a grant in a first physical downlink control channel monitoring occasion within a physical downlink control channel monitoring window, where the grant schedules a physical downlink shared channel slot aggregation for transmission of a SIB over consecutive slots based on the slot aggregation parameter.

In some examples, the RAR message component 1030 is capable of, configured to, or operable to support a means for receiving an indication of the slot aggregation parameter, a duration of a physical downlink control channel window, and a time offset to the physical downlink control channel window via the RAR message or via the uplink WUS configuration, or both.

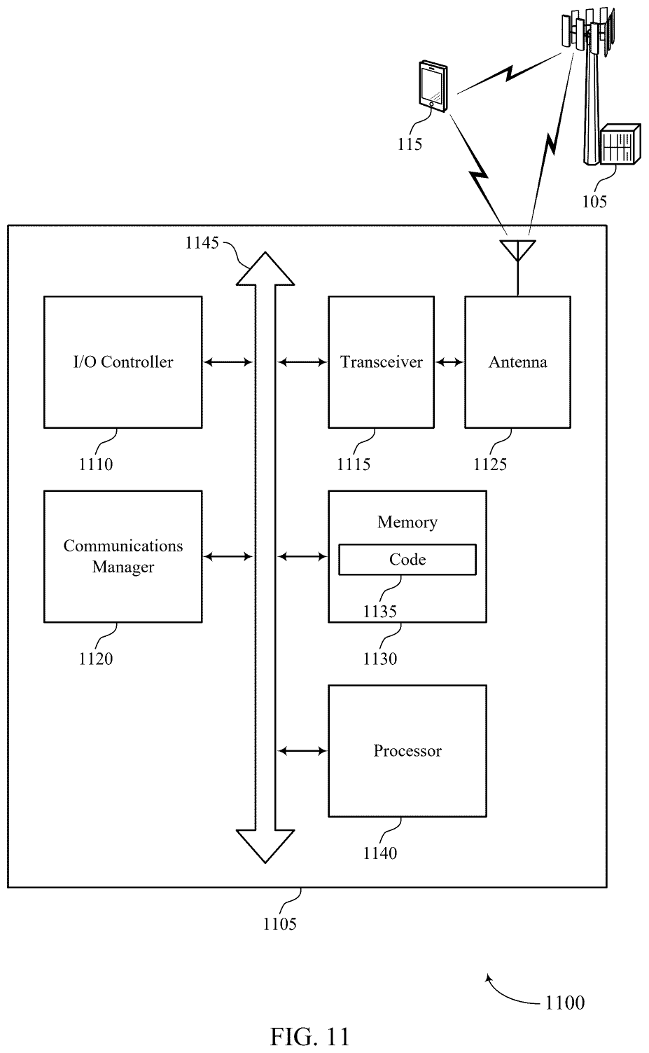

FIG. 11 shows a diagram of a system 1100 including a device 1105 that supports downlink control channel monitoring occasion configuration for on-demand system information in accordance with one or more aspects of the present disclosure.

The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting downlink control channel monitoring occasion configuration for on-demand system information). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a control signal indicating an uplink WUS configuration for on-demand SIB1 that is triggered by an uplink WUS. The communications manager 1120 is capable of, configured to, or operable to support a means for receiving, during an RAR window, an RAR message based on the uplink WUS. The communications manager 1120 is capable of, configured to, or operable to support a means for monitoring, based on the RAR message and during a physical downlink control channel window, for one or more on-demand SIBs, where the physical downlink control channel window includes a start time and a duration.

Additionally, or alternatively, the communications manager 1120 may support wireless communications in accordance with examples as disclosed herein. For example, the communications manager 1120 is capable of, configured to, or operable to support a means for receiving a control signal indicating an uplink WUS configuration for on-demand SIB1 that is triggered by an uplink WUS. The communications manager 1120 is capable of, configured to, or operable to support a means for receiving, during an RAR window, an RAR message based on the uplink WUS. The communications manager 1120 is capable of, configured to, or operable to support a means for monitoring a set of multiple physical downlink control channel monitoring occasions for a respective set of multiple SIBs based on a slot aggregation parameter indicated via the uplink WUS configuration or the RAR message, or both.

By including or configuring the communications manager 1120 in accordance with examples as described herein, the device 1105 may support techniques for reduced power consumption, more efficient utilization of communication resources, and longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of downlink control channel monitoring occasion configuration for on-demand system information as described herein, or the at least one processor 1140 and the at least one memory 1130 may be otherwise configured to, individually or collectively, perform or support such operations.

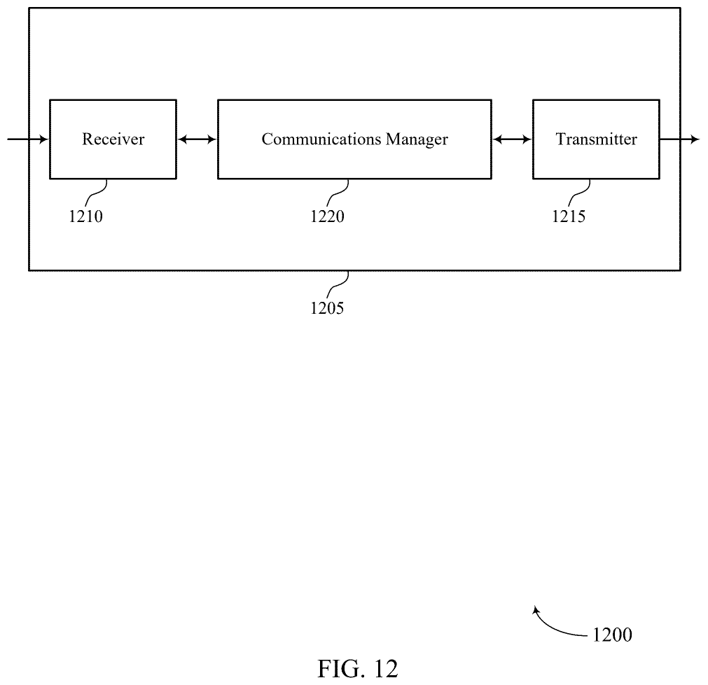

FIG. 12 shows a block diagram 1200 of a device 1205 that supports downlink control channel monitoring occasion configuration for on-demand system information in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of downlink control channel monitoring occasion configuration for on-demand system information as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting a control signal indicating an uplink WUS configuration for on-demand SIB1 that is triggered by an uplink WUS. The communications manager 1220 is capable of, configured to, or operable to support a means for outputting, during an RAR window, an RAR message based on the uplink WUS. The communications manager 1220 is capable of, configured to, or operable to support a means for outputting, based on the RAR message and during a physical downlink control channel window, one or more on-demand SIBs, where the physical downlink control channel window includes a start time and a duration.

Additionally, or alternatively, the communications manager 1220 may support wireless communications in accordance with examples as disclosed herein. For example, the communications manager 1220 is capable of, configured to, or operable to support a means for outputting a control signal indicating an uplink WUS configuration for on-demand SIB1 that is triggered by an uplink WUS. The communications manager 1220 is capable of, configured to, or operable to support a means for outputting, during an RAR window, an RAR message based on the uplink WUS. The communications manager 1220 is capable of, configured to, or operable to support a means for outputting, during a set of multiple physical downlink control channel monitoring occasions, a respective set of multiple SIBs based on a slot aggregation parameter indicated via the uplink WUS configuration or the RAR message, or both.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced power consumption and more efficient utilization of communication resources.

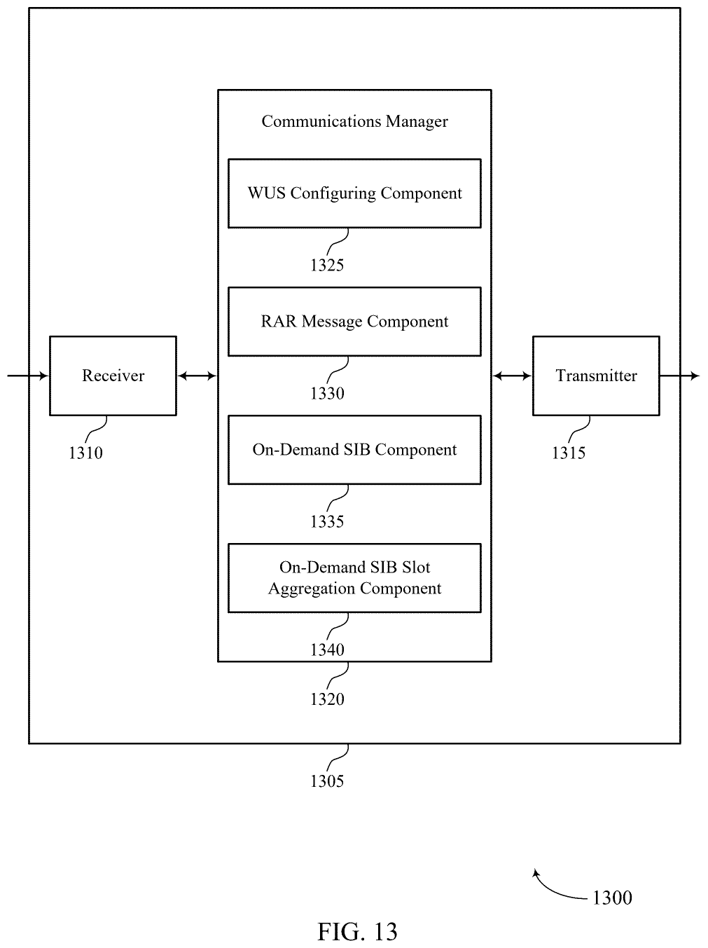

FIG. 13 shows a block diagram 1300 of a device 1305 that supports downlink control channel monitoring occasion configuration for on-demand system information in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of downlink control channel monitoring occasion configuration for on-demand system information as described herein. For example, the communications manager 1320 may include a WUS configuring component 1325, an RAR message component 1330, an on-demand SIB component 1335, an on-demand SIB slot aggregation component 1340, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The WUS configuring component 1325 is capable of, configured to, or operable to support a means for outputting a control signal indicating an uplink WUS configuration for on-demand SIB1 that is triggered by an uplink WUS. The RAR message component 1330 is capable of, configured to, or operable to support a means for outputting, during an RAR window, an RAR message based on the uplink WUS. The on-demand SIB component 1335 is capable of, configured to, or operable to support a means for outputting, based on the RAR message and during a physical downlink control channel window, one or more on-demand SIBs, where the physical downlink control channel window includes a start time and a duration.

Additionally, or alternatively, the communications manager 1320 may support wireless communications in accordance with examples as disclosed herein. The WUS configuring component 1325 is capable of, configured to, or operable to support a means for outputting a control signal indicating an uplink WUS configuration for on-demand SIB1 that is triggered by an uplink WUS. The RAR message component 1330 is capable of, configured to, or operable to support a means for outputting, during an RAR window, an RAR message based on the uplink WUS. The on-demand SIB slot aggregation component 1340 is capable of, configured to, or operable to support a means for outputting, during a set of multiple physical downlink control channel monitoring occasions, a respective set of multiple SIBs based on a slot aggregation parameter indicated via the uplink WUS configuration or the RAR message, or both.

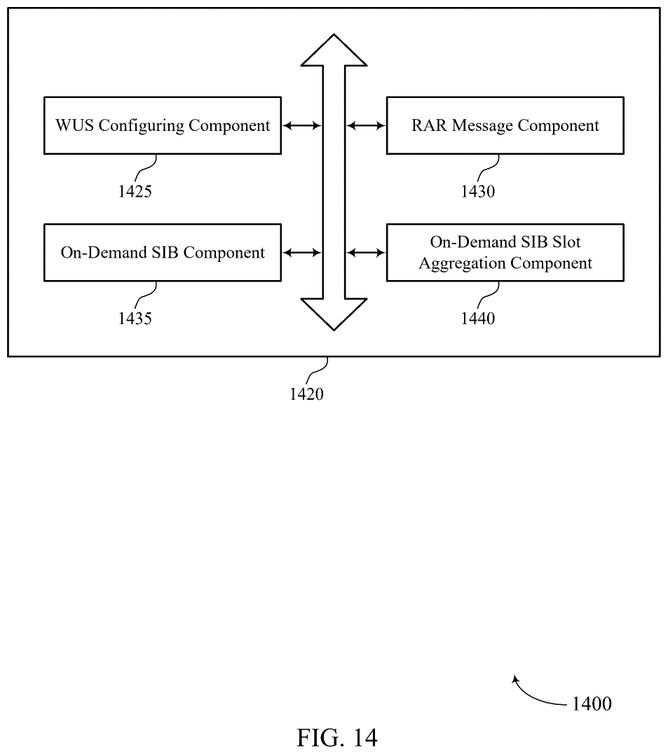

FIG. 14 shows a block diagram 1400 of a communications manager 1420 that supports downlink control channel monitoring occasion configuration for on-demand system information in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of downlink control channel monitoring occasion configuration for on-demand system information as described herein. For example, the communications manager 1420 may include a WUS configuring component 1425, an RAR message component 1430, an on-demand SIB component 1435, an on-demand SIB slot aggregation component 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The WUS configuring component 1425 is capable of, configured to, or operable to support a means for outputting a control signal indicating an uplink WUS configuration for on-demand SIB1 that is triggered by an uplink WUS. The RAR message component 1430 is capable of, configured to, or operable to support a means for outputting, during an RAR window, an RAR message based on the uplink WUS. The on-demand SIB component 1435 is capable of, configured to, or operable to support a means for outputting, based on the RAR message and during a physical downlink control channel window, one or more on-demand SIBs, where the physical downlink control channel window includes a start time and a duration.

In some examples, the WUS configuring component 1425 is capable of, configured to, or operable to support a means for outputting an indication of the start time, the duration, or both, via the uplink WUS configuration.

In some examples, the RAR message component 1430 is capable of, configured to, or operable to support a means for outputting an indication of the start time, the duration, or both, via the RAR message.

In some examples, the RAR message indicates one or more values, an index to a list of values, one or more delta values, or any combination thereof, to indicate the start time or the duration, or both.

In some examples, the start time of the physical downlink control channel window occurs after a time offset from a reference time point.

In some examples, the start time of the physical downlink control channel window aligns with a start of an earliest downlink control channel occasion after the time offset based on an index of an outputted synchronization signal block.

In some examples, the reference time point corresponds to the RAR window or a time of reception of the RAR message.

In some examples, the reference time point is configured via a static configuration, the uplink WUS configuration, the RAR message, or any combination thereof.

In some examples, the start time corresponds to a slot boundary or a symbol boundary based on a first downlink subcarrier spacing indicated by a master information block or a second downlink subcarrier spacing indicated by the uplink WUS configuration.

In some examples, the duration of the physical downlink control channel window corresponds to a first quantity of milliseconds, a second quantity of slots, a third quantity of synchronization signal block periods, or any combination thereof. In some examples, the second quantity of slots is based on a first downlink subcarrier spacing indicated by a master information block or a second downlink subcarrier spacing indicated by the uplink WUS configuration.

In some examples, the RAR message component 1430 is capable of, configured to, or operable to support a means for outputting, during the RAR window, a second RAR message based on a second WUS, where the RAR message indicates a first time offset to the physical downlink control channel window, and the second RAR message indicates a second time offset to the physical downlink control channel window.

In some examples, the RAR message component 1430 is capable of, configured to, or operable to support a means for outputting, during the RAR window, a second RAR message based on a second WUS, where the RAR message indicates a first time offset to the physical downlink control channel window, and the second RAR message indicates the first time offset to a second physical downlink control channel window.

Additionally, or alternatively, the communications manager 1420 may support wireless communications in accordance with examples as disclosed herein. In some examples, the WUS configuring component 1425 is capable of, configured to, or operable to support a means for outputting a control signal indicating an uplink WUS configuration for on-demand SIB1 that is triggered by an uplink WUS. In some examples, the RAR message component 1430 is capable of, configured to, or operable to support a means for outputting, during an RAR window, an RAR message based on the uplink WUS. The on-demand SIB slot aggregation component 1440 is capable of, configured to, or operable to support a means for outputting, during a set of multiple physical downlink control channel monitoring occasions, a respective set of multiple SIBs based on a slot aggregation parameter indicated via the uplink WUS configuration or the RAR message, or both.

In some examples, the respective set of multiple SIBs are outputted across a set of multiple SIB transmission repetition periods. In some examples, a physical downlink control channel monitoring window includes the set of multiple SIB transmission repetition periods.

In some examples, the on-demand SIB slot aggregation component 1440 is capable of, configured to, or operable to support a means for outputting a physical downlink control channel signal scheduling a grant in a first physical downlink control channel monitoring occasion within a physical downlink control channel monitoring window, where the grant schedules a physical downlink shared channel slot aggregation for transmission of a SIB over consecutive slots based on the slot aggregation parameter.

In some examples, the RAR message component 1430 is capable of, configured to, or operable to support a means for outputting, during a second RAR window, a second RAR message based on a second uplink WUS, where the RAR message indicates the slot aggregation parameter, and the second RAR message indicates a second slot aggregation parameter.

In some examples, the RAR message component 1430 is capable of, configured to, or operable to support a means for outputting, during a second RAR window, a second RAR message based on a second uplink WUS, where the RAR message indicates first timing information for a first physical downlink control channel window, and the second RAR message indicates second timing information for a second physical downlink control channel window.

In some examples, the WUS configuring component 1425 is capable of, configured to, or operable to support a means for outputting an indication of the slot aggregation parameter, a duration of a physical downlink control channel window, and a time offset to the physical downlink control channel window via the RAR message or via the uplink WUS configuration, or both.

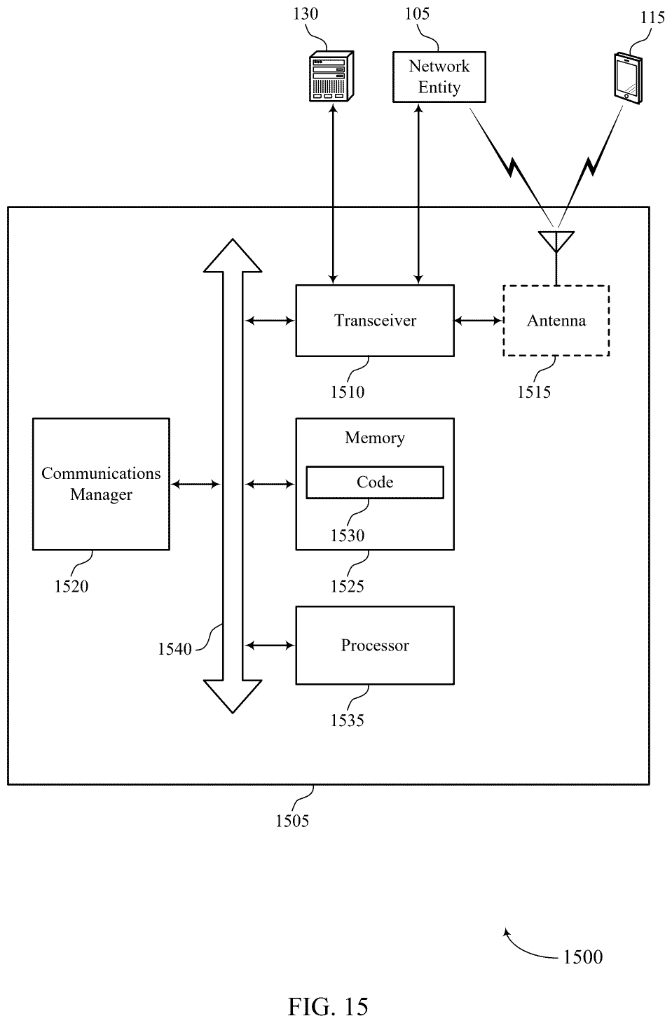

FIG. 15 shows a diagram of a system 1500 including a device 1505 that supports downlink control channel monitoring occasion configuration for on-demand system information in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting downlink control channel monitoring occasion configuration for on-demand system information). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting a control signal indicating an uplink WUS configuration for on-demand SIB1 that is triggered by an uplink WUS. The communications manager 1520 is capable of, configured to, or operable to support a means for outputting, during an RAR window, an RAR message based on the uplink WUS. The communications manager 1520 is capable of, configured to, or operable to support a means for outputting, based on the RAR message and during a physical downlink control channel window, one or more on-demand SIBs, where the physical downlink control channel window includes a start time and a duration.

Additionally, or alternatively, the communications manager 1520 may support wireless communications in accordance with examples as disclosed herein. For example, the communications manager 1520 is capable of, configured to, or operable to support a means for outputting a control signal indicating an uplink WUS configuration for on-demand SIB1 that is triggered by an uplink WUS. The communications manager 1520 is capable of, configured to, or operable to support a means for outputting, during an RAR window, an RAR message based on the uplink WUS. The communications manager 1520 is capable of, configured to, or operable to support a means for outputting, during a set of multiple physical downlink control channel monitoring occasions, a respective set of multiple SIBs based on a slot aggregation parameter indicated via the uplink WUS configuration or the RAR message, or both.

By including or configuring the communications manager 1520 in accordance with examples as described herein, the device 1505 may support techniques for reduced power consumption and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of downlink control channel monitoring occasion configuration for on-demand system information as described herein, or the at least one processor 1535 and the at least one memory 1525 may be otherwise configured to, individually or collectively, perform or support such operations.

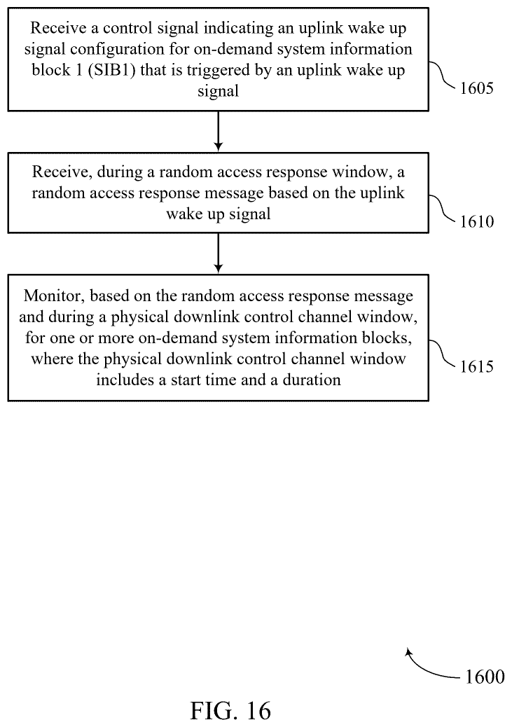

FIG. 16 shows a flowchart illustrating a method 1600 that supports downlink control channel monitoring occasion configuration for on-demand system information in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a control signal indicating an uplink WUS configuration for on-demand SIB1 that is triggered by an uplink WUS. The operations of 1605 may be performed in accordance with examples as disclosed herein. In some examples, aspects of the operations of 1605 may be performed by a WUS configuration component 1025 as described with reference to FIG. 10.

At 1610, the method may include receiving, during an RAR window, an RAR message based on the uplink WUS. The operations of 1610 may be performed in accordance with examples as disclosed herein. In some examples, aspects of the operations of 1610 may be performed by an RAR message component 1030 as described with reference to FIG. 10.

At 1615, the method may include monitoring, based on the RAR message and during a physical downlink control channel window, for one or more on-demand SIBs, where the physical downlink control channel window includes a start time and a duration. The operations of 1615 may be performed in accordance with examples as disclosed herein. In some examples, aspects of the operations of 1615 may be performed by an on-demand SIB monitoring component 1035 as described with reference to FIG. 10.

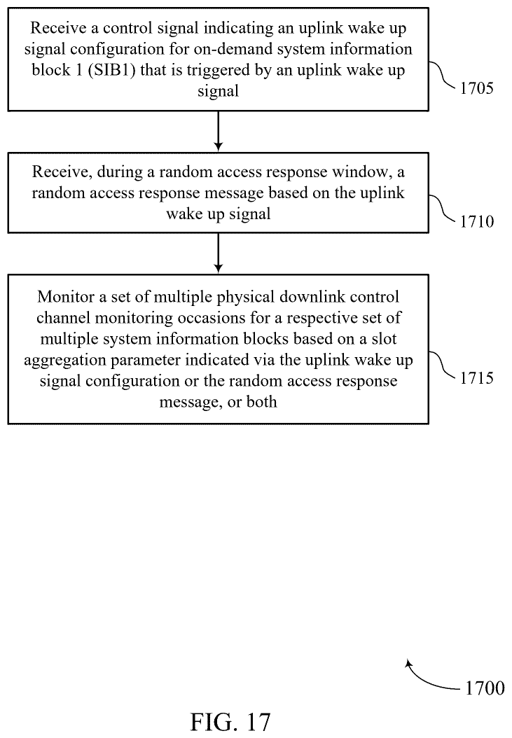

FIG. 17 shows a flowchart illustrating a method 1700 that supports downlink control channel monitoring occasion configuration for on-demand system information in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a control signal indicating an uplink WUS configuration for on-demand SIB1 that is triggered by an uplink WUS. The operations of 1705 may be performed in accordance with examples as disclosed herein. In some examples, aspects of the operations of 1705 may be performed by a WUS configuration component 1025 as described with reference to FIG. 10.

At 1710, the method may include receiving, during an RAR window, an RAR message based on the uplink WUS. The operations of 1710 may be performed in accordance with examples as disclosed herein. In some examples, aspects of the operations of 1710 may be performed by an RAR message component 1030 as described with reference to FIG. 10.

At 1715, the method may include monitoring a set of multiple physical downlink control channel monitoring occasions for a respective set of multiple SIBs based on a slot aggregation parameter indicated via the uplink WUS configuration or the RAR message, or both. The operations of 1715 may be performed in accordance with examples as disclosed herein. In some examples, aspects of the operations of 1715 may be performed by an on-demand SIB slot aggregation component 1040 as described with reference to FIG. 10.

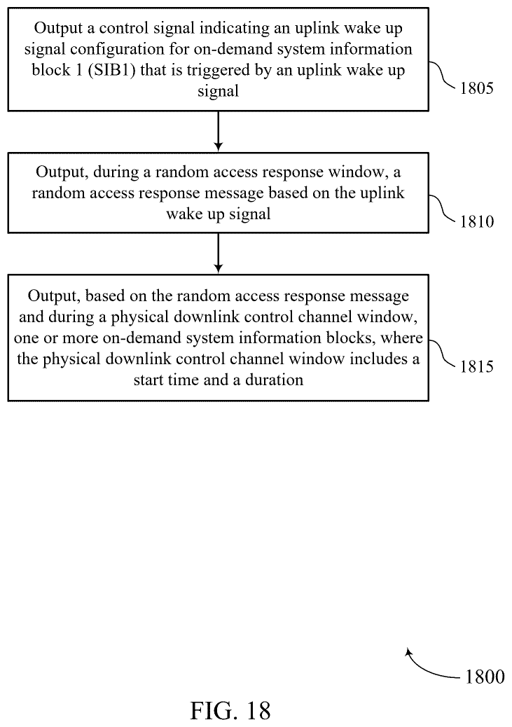

FIG. 18 shows a flowchart illustrating a method 1800 that supports downlink control channel monitoring occasion configuration for on-demand system information in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control signal indicating an uplink WUS configuration for on-demand SIB1 that is triggered by an uplink WUS. The operations of 1805 may be performed in accordance with examples as disclosed herein. In some examples, aspects of the operations of 1805 may be performed by a WUS configuring component 1425 as described with reference to FIG. 14.

At 1810, the method may include outputting, during an RAR window, an RAR message based on the uplink WUS. The operations of 1810 may be performed in accordance with examples as disclosed herein. In some examples, aspects of the operations of 1810 may be performed by an RAR message component 1430 as described with reference to FIG. 14.

At 1815, the method may include outputting, based on the RAR message and during a physical downlink control channel window, one or more on-demand SIBs, where the physical downlink control channel window includes a start time and a duration. The operations of 1815 may be performed in accordance with examples as disclosed herein. In some examples, aspects of the operations of 1815 may be performed by an on-demand SIB component 1435 as described with reference to FIG. 14.

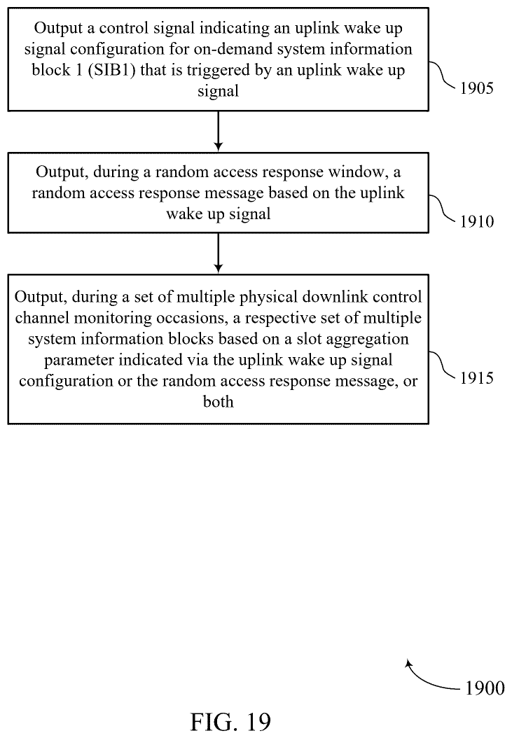

FIG. 19 shows a flowchart illustrating a method 1900 that supports downlink control channel monitoring occasion configuration for on-demand system information in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting a control signal indicating an uplink WUS configuration for on-demand SIB1 that is triggered by an uplink WUS. The operations of 1905 may be performed in accordance with examples as disclosed herein. In some examples, aspects of the operations of 1905 may be performed by a WUS configuring component 1425 as described with reference to FIG. 14.

At 1910, the method may include outputting, during an RAR window, an RAR message based on the uplink WUS. The operations of 1910 may be performed in accordance with examples as disclosed herein. In some examples, aspects of the operations of 1910 may be performed by an RAR message component 1430 as described with reference to FIG. 14.

At 1915, the method may include outputting, during a set of multiple physical downlink control channel monitoring occasions, a respective set of multiple SIBs based on a slot aggregation parameter indicated via the uplink WUS configuration or the RAR message, or both. The operations of 1915 may be performed in accordance with examples as disclosed herein. In some examples, aspects of the operations of 1915 may be performed by an on-demand SIB slot aggregation component 1440 as described with reference to FIG. 14.

The following provides an overview of aspects of the present disclosure:

Aspect 1: A method for wireless communications at a UE, comprising: receiving a control signal indicating an uplink wake up signal configuration for on-demand system information block 1 (SIB1) that is triggered by an uplink wake up signal; receiving, during a random access response window, a random access response message based at least in part on the uplink wake up signal; and monitoring, based at least in part on the random access response message and during a physical downlink control channel window, for one or more on-demand system information blocks, wherein the physical downlink control channel window comprises a start time and a duration.

Aspect 2: The method of aspect 1, further comprising: receiving an indication of the start time, the duration, or both, from the uplink wake up signal configuration.

Aspect 3: The method of any of aspects 1 through 2, further comprising: receiving an indication of the start time, the duration, or both, from the random access response message.

Aspect 4: The method of aspect 3, wherein the random access response message indicates one or more values, an index to a list of values, one or more delta values, or any combination thereof, to indicate the start time or the duration, or both.

Aspect 5: The method of any of aspects 1 through 4, wherein the start time of the physical downlink control channel window occurs after a time offset from a reference time point.

Aspect 6: The method of aspect 5, wherein the start time of the physical downlink control channel window aligns with a start of an earliest downlink control channel occasion after the time offset based at least in part on an index of a received synchronization signal block.

Aspect 7: The method of any of aspects 5 through 6, wherein the reference time point corresponds to the random access response window or a time of reception of the random access response message.

Aspect 8: The method of any of aspects 5 through 7, wherein the reference time point is configured via a static configuration, the uplink wake up signal configuration, the random access response message, or any combination thereof.

Aspect 9: The method of any of aspects 5 through 8, wherein the time offset is specified in a technical specification based on a physical downlink shared channel processing latency for the random access response message.

Aspect 10: The method of any of aspects 5 through 9, wherein the reference time point is specified in a technical specification.

Aspect 11: The method of any of aspects 1 through 10, wherein the start time corresponds to a slot boundary or a symbol boundary based at least in part on a first downlink subcarrier spacing indicated by a master information block or a second downlink subcarrier spacing indicated by the uplink wake up signal configuration.

Aspect 12: The method of any of aspects 1 through 11, wherein the duration of the physical downlink control channel window corresponds to a first quantity of milliseconds, a second quantity of slots, a third quantity of synchronization signal block periods, or any combination thereof, and the second quantity of slots is based at least in part on a first downlink subcarrier spacing indicated by a master information block or a second downlink subcarrier spacing indicated by the uplink wake up signal configuration.

Aspect 13: A method for wireless communications at a UE, comprising: receiving a control signal indicating an uplink wake up signal configuration for on-demand system information block 1 (SIB1) that is triggered by an uplink wake up signal; receiving, during a random access response window, a random access response message based at least in part on the uplink wake up signal; and monitoring a plurality of physical downlink control channel monitoring occasions for a respective plurality of system information blocks based on a slot aggregation parameter indicated via the uplink wake up signal configuration or the random access response message, or both.

Aspect 14: The method of aspect 13, wherein monitoring the plurality of physical downlink control channel monitoring occasions comprises: monitoring the plurality of physical downlink control channel monitoring occasions across a plurality of system information block transmission repetition periods, wherein a physical downlink control channel monitoring window comprises the plurality of system information block transmission repetition periods.

Aspect 15: The method of any of aspects 13 through 14, further comprising: receiving a physical downlink control channel signal scheduling a grant in a first physical downlink control channel monitoring occasion within a physical downlink control channel monitoring window, wherein the grant schedules a physical downlink shared channel slot aggregation for transmission of a system information block over consecutive slots based at least in part on the slot aggregation parameter.

Aspect 16: The method of any of aspects 13 through 15, further comprising: receiving an indication of the slot aggregation parameter, a duration of a physical downlink control channel window, and a time offset to the physical downlink control channel window via the random access response message or via the uplink wake up signal configuration, or both.

Aspect 17: A method for wireless communications at a network entity, comprising: outputting a control signal indicating an uplink wake up signal configuration for on-demand system information block 1 (SIB1) that is triggered by an uplink wake up signal; outputting, during a random access response window, a random access response message based at least in part on the uplink wake up signal; and outputting, based at least in part on the random access response message and during a physical downlink control channel window, one or more on-demand system information blocks, wherein the physical downlink control channel window comprises a start time and a duration.

Aspect 18: The method of aspect 17, further comprising: outputting an indication of the start time, the duration, or both, via the uplink wake up signal configuration.

Aspect 19: The method of any of aspects 17 through 18, further comprising: outputting an indication of the start time, the duration, or both, via the random access response message.

Aspect 20: The method of aspect 19, wherein the random access response message indicates one or more values, an index to a list of values, one or more delta values, or any combination thereof, to indicate the start time or the duration, or both.

Aspect 21: The method of any of aspects 17 through 20, wherein the start time of the physical downlink control channel window occurs after a time offset from a reference time point.

Aspect 22: The method of aspect 21, wherein the start time of the physical downlink control channel window aligns with a start of an earliest downlink control channel occasion after the time offset based at least in part on an index of an outputted synchronization signal block.

Aspect 23: The method of any of aspects 21 through 22, wherein the reference time point corresponds to the random access response window or a time of reception of the random access response message.

Aspect 24: The method of any of aspects 21 through 23, wherein the reference time point is configured via a static configuration, the uplink wake up signal configuration, the random access response message, or any combination thereof.

Aspect 25: The method of any of aspects 17 through 24, wherein the start time corresponds to a slot boundary or a symbol boundary based at least in part on a first downlink subcarrier spacing indicated by a master information block or a second downlink subcarrier spacing indicated by the uplink wake up signal configuration.

Aspect 26: The method of any of aspects 17 through 25, wherein the duration of the physical downlink control channel window corresponds to a first quantity of milliseconds, a second quantity of slots, a third quantity of synchronization signal block periods, or any combination thereof, and the second quantity of slots is based at least in part on a first downlink subcarrier spacing indicated by a master information block or a second downlink subcarrier spacing indicated by the uplink wake up signal configuration.

Aspect 27: The method of any of aspects 17 through 26, further comprising: outputting, during the random access response window, a second random access response message based at least in part on a second wake up signal, wherein the random access response message indicates a first time offset to the physical downlink control channel window, and the second random access response message indicates a second time offset to the physical downlink control channel window.

Aspect 28: The method of any of aspects 17 through 27, further comprising: outputting, during the random access response window, a second random access response message based at least in part on a second wake up signal, wherein the random access response message indicates a first time offset to the physical downlink control channel window, and the second random access response message indicates the first time offset to a second physical downlink control channel window.

Aspect 29: A method for wireless communications at a network entity, comprising: outputting a control signal indicating an uplink wake up signal configuration for on-demand system information block 1 (SIB1) that is triggered by an uplink wake up signal; outputting, during a random access response window, a random access response message based at least in part on the uplink wake up signal; and outputting, during a plurality of physical downlink control channel monitoring occasions, a respective plurality of system information blocks based on a slot aggregation parameter indicated via the uplink wake up signal configuration or the random access response message, or both.

Aspect 30: The method of aspect 29, wherein the respective plurality of system information blocks are outputted across a plurality of system information block transmission repetition periods, a physical downlink control channel monitoring window comprises the plurality of system information block transmission repetition periods.

Aspect 31: The method of any of aspects 29 through 30, further comprising: outputting a physical downlink control channel signal scheduling a grant in a first physical downlink control channel monitoring occasion within a physical downlink control channel monitoring window, wherein the grant schedules a physical downlink shared channel slot aggregation for transmission of a system information block over consecutive slots based at least in part on the slot aggregation parameter.

Aspect 32: The method of any of aspects 29 through 31, further comprising: outputting, during a second random access response window, a second random access response message based at least in part on a second uplink wake up signal, wherein the random access response message indicates the slot aggregation parameter, and the second random access response message indicates a second slot aggregation parameter.

Aspect 33: The method of any of aspects 29 through 32, further comprising: outputting, during a second random access response window, a second random access response message based at least in part on a second uplink wake up signal, wherein the random access response message indicates first timing information for a first physical downlink control channel window, and the second random access response message indicates second timing information for a second physical downlink control channel window.

Aspect 34: The method of any of aspects 29 through 33, further comprising: outputting an indication of the slot aggregation parameter, a duration of a physical downlink control channel window, and a time offset to the physical downlink control channel window via the random access response message or via the uplink wake up signal configuration, or both.

Aspect 35: A UE for wireless communications, comprising one or more memories storing processor-executable code, and one or more processors coupled with the one or more memories and individually or collectively operable to execute the code to cause the UE to perform a method of any of aspects 1 through 12.

Aspect 36: A UE for wireless communications, comprising at least one means for performing a method of any of aspects 1 through 12.

Aspect 37: A non-transitory computer-readable medium storing code for wireless communications, the code comprising instructions executable by one or more processors to perform a method of any of aspects 1 through 12.

Aspect 38: A UE for wireless communications, comprising one or more memories storing processor-executable code, and one or more processors coupled with the one or more memories and individually or collectively operable to execute the code to cause the UE to perform a method of any of aspects 13 through 16.

Aspect 39: A UE for wireless communications, comprising at least one means for performing a method of any of aspects 13 through 16.

Aspect 40: A non-transitory computer-readable medium storing code for wireless communications, the code comprising instructions executable by one or more processors to perform a method of any of aspects 13 through 16.

Aspect 41: A network entity for wireless communications, comprising one or more memories storing processor-executable code, and one or more processors coupled with the one or more memories and individually or collectively operable to execute the code to cause the network entity to perform a method of any of aspects 17 through 28.

Aspect 42: A network entity for wireless communications, comprising at least one means for performing a method of any of aspects 17 through 28.

Aspect 43: A non-transitory computer-readable medium storing code for wireless communications, the code comprising instructions executable by one or more processors to perform a method of any of aspects 17 through 28.

Aspect 44: A network entity for wireless communications, comprising one or more memories storing processor-executable code, and one or more processors coupled with the one or more memories and individually or collectively operable to execute the code to cause the network entity to perform a method of any of aspects 29 through 34.

Aspect 45: A network entity for wireless communications, comprising at least one means for performing a method of any of aspects 29 through 34.

Aspect 46: A non-transitory computer-readable medium storing code for wireless communications, the code comprising instructions executable by one or more processors to perform a method of any of aspects 29 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control signal indicating an uplink wake up signal configuration for on-demand system information block 1 (SIB1) that is triggered by an uplink wake up signal;
receive, during a random access response window, a random access response message based at least in part on the uplink wake up signal; and
monitor, based at least in part on the random access response message and during a physical downlink control channel window, for one or more on-demand system information blocks, wherein the physical downlink control channel window comprises a start time and a duration.

2. The UE of claim 1, wherein the start time of the physical downlink control channel window occurs after a time offset from a reference time point.

3. The UE of claim 2, wherein the start time of the physical downlink control channel window aligns with a start of an earliest downlink control channel occasion after the time offset based at least in part on an index of a received synchronization signal block.

4. The UE of claim 2, wherein the reference time point corresponds to the random access response window or a time of reception of the random access response message.

5. The UE of claim 2, wherein the uplink wake up signal configuration or the random access response message includes a configuration for the reference time point.

6. The UE of claim 2, wherein the time offset is specified in a technical specification based on a physical downlink shared channel processing latency for the random access response message.

7. The UE of claim 2, wherein the reference time point is specified in a technical specification.

8. The UE of claim 1, wherein the one or more processors are individually or collectively further operable to execute the code to cause the UE to:
receive an indication of the start time, the duration, or both, from the uplink wake up signal configuration.

9. The UE of claim 1, wherein the one or more processors are individually or collectively further operable to execute the code to cause the UE to:
receive an indication of the start time, the duration, or both, from the random access response message.

10. The UE of claim 9, wherein the random access response message indicates one or more values, an index to a list of values, one or more delta values, or any combination thereof, to indicate the start time or the duration, or both.

11. The UE of claim 1, wherein the start time corresponds to a slot boundary or a symbol boundary based at least in part on a first downlink subcarrier spacing indicated by a master information block or a second downlink subcarrier spacing indicated by the uplink wake up signal configuration.

12. The UE of claim 1, wherein:
the duration of the physical downlink control channel window corresponds to a first quantity of milliseconds, a second quantity of slots, a third quantity of synchronization signal block periods, or any combination thereof, and
the second quantity of slots is based at least in part on a first downlink subcarrier spacing indicated by a master information block or a second downlink subcarrier spacing indicated by the uplink wake up signal configuration.

13. A user equipment (UE), comprising:
one or more memories storing processor-executable code; and
one or more processors coupled with the one or more memories and individually or collectively operable to execute the code to cause the UE to:
receive a control signal indicating an uplink wake up signal configuration for on-demand system information block 1 (SIB1) that is triggered by an uplink wake up signal;
receive, during a random access response window, a random access response message based at least in part on the uplink wake up signal; and
monitor a plurality of physical downlink control channel monitoring occasions for a respective plurality of system information blocks based on a slot aggregation parameter indicated via the uplink wake up signal configuration or the random access response message, or both.

14. The UE of claim 13, wherein, to monitor the plurality of physical downlink control channel monitoring occasions, the one or more processors are individually or collectively operable to execute the code to cause the UE to:
monitor the plurality of physical downlink control channel monitoring occasions across a plurality of system information block transmission repetition periods, wherein a physical downlink control channel monitoring window comprises the plurality of system information block transmission repetition periods.

15. The UE of claim 13, wherein the one or more processors are individually or collectively further operable to execute the code to cause the UE to:
receive a physical downlink control channel signal scheduling a grant in a first physical downlink control channel monitoring occasion within a physical downlink control channel monitoring window, wherein the grant schedules a physical downlink shared channel slot aggregation for transmission of a system information block over consecutive slots based at least in part on the slot aggregation parameter.

16. The UE of claim 13, wherein the one or more processors are individually or collectively further operable to execute the code to cause the UE to:
receive an indication of the slot aggregation parameter, a duration of a physical downlink control channel window, and a time offset to the physical downlink control channel window via the random access response message or via the uplink wake up signal configuration, or both.

17. A method for wireless communications at a user equipment (UE), comprising:
receiving a control signal indicating an uplink wake up signal configuration for on-demand system information block 1 (SIB1) that is triggered by an uplink wake up signal;
receiving, during a random access response window, a random access response message based at least in part on the uplink wake up signal; and
monitoring a plurality of physical downlink control channel monitoring occasions for a respective plurality of system information blocks based on a slot aggregation parameter indicated via the uplink wake up signal configuration or the random access response message, or both.

18. The method of claim 17, wherein monitoring the plurality of physical downlink control channel monitoring occasions comprises:
monitoring the plurality of physical downlink control channel monitoring occasions across a plurality of system information block transmission repetition periods, wherein a physical downlink control channel monitoring window comprises the plurality of system information block transmission repetition periods.

19. The method of claim 17, further comprising:
receiving a physical downlink control channel signal scheduling a grant in a first physical downlink control channel monitoring occasion within a physical downlink control channel monitoring window, wherein the grant schedules a physical downlink shared channel slot aggregation for transmission of a system information block over consecutive slots based at least in part on the slot aggregation parameter.

20. The method of claim 17, further comprising:
receiving an indication of the slot aggregation parameter, a duration of a physical downlink control channel window, and a time offset to the physical downlink control channel window via the random access response message or via the uplink wake up signal configuration, or both.
